(19) United States
(12) Patent Application Publication
(10) Pub. No.: US 2019/0188665 A1
(43) Pub. Date: Jun. 20, 2019

(54) Paperless Payment System and Method Thereof

(71) Applicant: Jianlin DAI, Maanshan (CN)

(72) Inventor: Jianlin DAI, Maanshan (CN)

(21) Appl. No.: 15/752,233

(22) PCT Filed: Aug. 12, 2016
(86) PCT No.: PCT/CN2016/094840

§ 371 Date: Nov. 26, 2018

(30) Foreign Application Priority Data
Aug. 12, 2015 (CN) 2015104982009

(51) Int. Cl. G06Q 20/14; G06Q 40/00; G06Q 20/40; G06Q 20/24

(52) U.S. Cl. CPC G06Q 20/14; G06Q 40/10; G06Q 20/327; G06Q 20/24; G06Q 20/40

(57) ABSTRACT

A paperless payment system includes a payment center which makes a payment according to a preset paperless payment file, wherein the paperless payment file further comprises at least a payment plan. The payment center verifies current payment information with the payment plan of the paperless payment file. If the current payment information conforms to the payment plan, the payment center makes a payment according to the payment plan of the paperless payment file.

### CROSS REFERENCE OF RELATED APPLICATION

This is a U.S. National Stage under 35 U.S.C. 371 of the International Application Number PCT/CN2016/094840, filed Aug. 12, 2016, which claims priority under 35 U.S.C. 119(a-d) to Chinese application number 2015104982009, filed Aug. 12, 2015. The afore-mentioned patent applications are hereby incorporated by reference in their entireties.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

### Field of Invention

The present invention relates to payment system, and more particularly to a paperless payment system and method thereof, wherein the paperless payment system can provide a paperless payment file for establishing a payment plan and the payment can only be made if the paying process conforms to the payment plan.

### Description of Related Arts

Money, especially banknote, is a common means of payment. When people utilize banknote to make payments, the seller has to tell the buyer the price of the merchandise. Then the buyer can pick up banknotes with corresponding denomination according to the price of the merchandise and hand them to the seller. If the denomination of the banknote selected by the buyer equals to the price of the merchandise, the payment will be completed. If the denomination of the banknote selected by the buyer is greater than the price of the merchandise, the seller will have to return the banknote of the denomination corresponding to the price difference to the buyer, so as to complete the payment. In such process of banknote transaction, both the seller and the buyer have to check the denomination of the banknote and to verify the validity of the banknote. Hence, both the seller and the buyer will have to be able to verify the validity of the banknote, which increases the cost of utilizing banknote as a means of payment. A banknote usually has a definite denomination, so if the amount of the payment exceeds the denomination of the banknote, the seller will have to calculate the required quantity of the banknote of the denomination for the payment. If the amount of the payment is huge, it will take a great effort to carry, check, and validate the banknotes. In such cases, the cost of the payment will be high.

Next, credit card is another means of payment. Comparing with banknote, it is easier to carry a credit card and not to check the amount. The process of utilizing a credit card to make a payment includes reading the information on the credit card with a card reader, optionally having the buyer to input a pin, having the buyer to sign his/her name to complete the payment. Although credit card is easy to use, nevertheless once the credit card information is copied and the signature of the buyer is forged, it will render a significant loss to the issuing bank. This is because that it requires a better identification intelligence to identify a fraudulent use of credit card and regular merchants do not have such ability. Nonetheless, the action to enhance the merchants' ability of identifying a fraudulent use of credit card will increase the payment cost. Besides, a user has to pass a credit review in order to obtain a credit card, otherwise she/he cannot enjoy the convenience of utilizing credit card. Unfortunately, credit review requires costs as well. Moreover, even an error occurred in the credit review can render a loss to the issuer, but it costs more for a more careful credit review. The costs of credit review will eventually be transferred to the user, which raises the payment cost for the user to utilize credit card.

In addition, one of the reasons that it is difficult for minor enterprises to obtain loans is because it is hard to control the actual use of the loan. Namely, a business owner may apply for a loan for a project, but spend the loan on other purposes, which causes uncovered loan and losses to the lender. What happens is that it utilizes credit review and project evaluation to audit before lending. However, the lender can only conduct the examinations before lending, but cannot control the actual use of the loan afterward. Although it has spent a lot on credit review and project evaluation, losses may still occur.

As a result, banks often tend not to lend to minor enterprises. There has not been an ideal solution to control the actual use of the loan.

Lastly, some numbers have close relation to our daily life, for example, a birth certificate number right after a person is born. Then it is the identification card number. There is a student ID number for school and a diploma number when graduated. There are different diploma numbers in different stages. Depositing in the bank requires bankcard number or bankbook number. Bankcards of various banking businesses have different card numbers too. There are preferential card numbers for supermarket shopping. Various types of numbers gradually raise the difficulty of the management and bring inconvenience or even trouble to our lives. It wastes time and energy when people have to distinguish the corresponding purposes of these numbers. If there is a number able to achieve the functions and purposes of the all of the above numbers, it will be extremely convenient for our lives. Unfortunately, such number does not exist.

### SUMMARY OF THE PRESENT INVENTION

An object of the present invention is to provide a paperless payment system, wherein the paperless payment system provides a paperless payment file for presetting at least a payment plan.

Another object of the present invention is to provide a paperless payment system, wherein the paperless payment system verifies the payment plan preset in the acquired paperless payment file in order to make a payment.

Another object of the present invention is to provide a paperless payment system, which utilizes value constant as the paying unit thereof.

Another object of the present invention is to provide a paperless payment system, wherein the paperless payment file provides at least a payment plan and at least a verification plan, wherein the paperless payment system verifies the payment plan and the current payment information as well as verifies the verification plan and the identity of the payer.

Another object of the present invention is to provide a paperless payment system, wherein the paperless payment system provides a generation center to generate the paperless payment file.

Another object of the present invention is to provide a paperless payment system, wherein the generation center provides a plan providing unit, wherein the plan providing unit is provided for establishing the payment plan.

Another object of the present invention is to provide a paperless payment system, wherein the plan providing unit is provided for establishing the verification plan.

Another object of the present invention is to provide a paperless payment system, wherein the generation center provides a generating unit, wherein the generating unit generates the paperless payment file according to the provided payment plan.

Another object of the present invention is to provide a paperless payment system, wherein the generation center provides a generating unit, wherein the generating unit generates the paperless payment file according to the provided payment plan and verification plan.

Another object of the present invention is to provide a paperless payment system, wherein the generation center provides an authorization unit, wherein the authorization unit allows the user to verify the payment plan and the verification plan.

Another object of the present invention is to provide a paperless payment system, wherein the paperless payment system provides a payment center, which verifies the payment plan and the current payment information and makes the payment if the current payment information conforms to the payment plan.

Another object of the present invention is to provide a paperless payment system, wherein the payment center verifies the verification plan and the identity of the payer and makes the payment if the identity of the payer conforms to the verification plan.

Another object of the present invention is to provide a paperless payment system, wherein the payment center provides a content acquiring unit, wherein the content acquiring unit acquires the payment plan of the paperless payment file.

Another object of the present invention is to provide a paperless payment system, wherein the payment center provides a content acquiring unit, wherein the content acquiring unit acquires the verification plan of the paperless payment file.

Another object of the present invention is to provide a paperless payment system, wherein the payment center provides a verification unit, wherein the verification unit verifies the payment plan and the current payment information.

Another object of the present invention is to provide a paperless payment system, wherein the payment center provides a verification unit, wherein the verification unit verifies the verification plan and the identity of the payer.

Another object of the present invention is to provide a paperless payment system, wherein the payment center provides a payment unit, wherein the payment unit making the payment according to the payment plan of the paperless payment file.

Another object of the present invention is to provide a paperless payment system, wherein the paperless payment system further provides a value constant management center, wherein the value constant management center manages the value constant of the users.

Another object of the present invention is to provide a paperless payment system, wherein the value constant management center assigns an identifier to each user correspondingly, wherein the value constant management center manages the value constant of the user based on the corresponding identifier.

Another object of the present invention is to provide a paperless payment system, wherein the value constant management center further provides a user management unit, wherein the user management unit is for managing the general information of the user.

Another object of the present invention is to provide a paperless payment system, wherein the user management unit assigns corresponding identifier to the user respectively.

Another object of the present invention is to provide a paperless payment system, wherein the value constant management center further provides a value constant management unit, wherein the value constant management unit manages the value unit of the user based on the identifier of the user.

Another object of the present invention is to provide a paperless payment system, wherein the value constant management center provides a credit unit, wherein the credit unit provides preset credit limits of the users corresponding to the identifiers thereof respectively.

Another object of the present invention is to provide a paperless payment system, wherein the payment plan can be configured to utilize the credit limit of the user to make the payment.

Another object of the present invention is to provide a paperless payment system, wherein the paperless payment system provides a crowdfunding center, which allows at least a crowdfunding project to be published, wherein if a paperless payment file of the crowdfunding project is established, the payment center can make the payment to the participantof the crowdfunding project based on the paperless payment file of the crowdfunding project.

Another object of the present invention is to provide a paperless payment system, wherein the paperless payment system also provides a tax center, which determines if a payment made through the paperless payment file has to pay tax. If tax is required, the tax center will send a paperless payment file of tax to the payment center and the payment center will execute the paperless payment file and the paperless payment file of tax to respectively make the payment and the taxation.

Another object of the present invention is to provide a paperless payment system, wherein the paperless payment system further provides an accounting management module, wherein after a payment is made through utilizing a paperless payment file, the payment center will send a payment status receipt to the accounting management module and the accounting management module will record the payment status of the corresponding user based on the identifier of the user.

In order to achieve the above and other objects, the present invention provides a paperless payment system, comprising a payment center makes a payment according to a preset paperless payment file, wherein the paperless payment file further comprises at least a payment plan. The payment center verifies a current payment information with the payment plan of the paperless payment file. If the current payment information conforms to the payment plan, the payment center makes a payment according to the payment plan of the paperless payment file. The paperless payment system according to the present invention further comprises a generation center, which generates the paperless payment file, wherein the generation center is adapted to provide at least one payment plan that the generation center generates the paperless payment file according to the payment plan provided thereby.

The paperless payment file further comprises at least a verification plan, provided by the generation center, for the payment center to verify the identity of the payer according to the verification plan, wherein the payment center makes the payment according to the payment plan of the paperless payment file if the identity of the payer conforms to the verification plan.

The generation center further comprises a plan providing unit and a generating unit communicating and connecting with the plan providing unit, wherein the plan providing unit provides the payment plan, wherein the generating unit generates the paperless payment file according to the payment plan.

The payment center further comprises a content acquiring unit, a verification unit, and a payment unit interconnected and intercommunicated with one another, wherein the content acquiring unit acquires the current payment information and the payment plan of the paperless payment file and sends the current payment information and the payment plan of the paperless payment file to the verification unit, wherein the verification unit verifies if the current payment information conforms to the payment plan of the paperless payment file, wherein the payment unit makes a payment according to the payment plan of the paperless payment file if the current payment information conforms to the payment plan of the paperless payment file.

The plan providing unit is provided for establishing the verification plan, wherein the verification unit verifies the identity of the authorized person of the paperless payment file according to the verification plan, wherein the paperless payment file acquires authorization if the verification unit confirms the identity of the authorized person, wherein the payment unit will make a payment according to the payment plan of the paperless payment file.

The generation center further comprises an authorization unit communicating and connecting with the plan providing unit and the generating unit respectively, wherein the user examines the payment plan through the authorization unit, wherein the payment plan will be sent to the generating unit if the payment plan is approved by the user, wherein the generating unit will generate the paperless payment file according to the generating unit.

The paperless payment system of the present invention further comprises a value constant management center communicating and connecting with the generation center and the payment center respectively, wherein the value constant management center manages the value constants owned by the users by means of identifiers, wherein the paperless payment system makes payments by the value constant.

The value constant management center further comprises a user management unit and a value constant management unit, wherein the user management unit manages information of the users, wherein the user management unit arranges corresponding account for the user respectively, wherein the value constant management unit manages the value constant owned by the user based on the corresponding account of the user.

The present invention further provides a paperless payment system, comprising

a value constant management center, assigning an identifier to each user correspondingly, wherein the value constant management center manages the value constant of the user based on the corresponding identifier; and

a payment center, communicates and connects with the value constant management center, wherein the payment center makes payments according to a preset paperless payment file, wherein the paperless payment file comprises at least a payment plan, wherein the payment center verifies the current payment information with the payment plan of the paperless payment file and make payment according to the payment plan of the paperless payment file if the current payment information conforms to the payment plan of the paperless payment file, wherein the value constant management center respectively adjust the value constant limit owned by the payer and the value constant limit owned by the payee according to the identifiers of the payer and the payee provided in the payment plan of the paperless payment file during the paying process of the payment center, so as to transfer the amount of the value constant equal the payment limit configured in the paperless payment file from the identifier of the payer to the identifier of the payee.

The paperless payment system according to the present invention further comprises a generation center, which generates at least a paperless payment file and communicates and connects with the payment center, wherein the generation center is adapted to provide a payment plan and then generates at least a the paperless payment file according to the payment plan provided thereby.

The value constant management center further comprises a user management unit and a value constant management unit, wherein the user management unit assigns corresponding identifier to the user, while the value constant management unit manages the value constant of the user according to the corresponding identifier.

The value constant management center further comprises a credit unit, which manages the credit limit of the user based on the corresponding identifier. The credit limit of the user can be configured in the payment plan of the paperless payment file, such that the credit limit of the user can be utilized to make payments through the payment center.

The paperless payment system of the present invention further comprises a crowdfunding center, which manages the crowdfunding project published by the user according to the identifier of the user. The crowdfunding center allows at least a crowdfunding project to be published. The generation center establishes and provides the payment plan of the crowdfunding project according to the crowdfunding project and generates the paperless payment file of the crowdfunding project based on the payment plan of the crowdfunding project. Every profit that the crowdfunding project gains will be paid to the identifiers of the participants by the payment center based on the shares of the participants configured in the payment plan of the paperless payment file of the crowdfunding project.

The paperless payment system of the present invention further comprises a tax center, connecting with the crowdfunding center, the generation center, the payment center, and the value constant management center respectively, wherein the tax center manages the payable taxation of the user according to the identifier thereof, wherein the tax center provides at least a tax rule and determines if the payment made by the payment center according to the paperless payment file conforms to the tax rule, wherein if the payment conforms to the tax rule, when making the payment with the paperless payment file based on the tax rule, the tax center will make a corresponding tax payment.

The paperless payment system of the present invention further comprises an accounting management module, communicating and connecting with the payment center, the tax center, and the value constant management center respectively, wherein the accounting management module and the identifier of the user manage the financial status of the user, wherein the payment center sends a payment status receipt to the accounting management module after the payment has been made based on the paperless payment file, wherein the accounting management module records according to the payment status on the identifiers of the payer and payee respectively.

The present invention further provides a method of paperless payment, comprising the following steps:

1. acquiring the current payment information and a payment plan of a paperless payment file.

2. verifying the current payment information and the payment plan of the paperless payment file, wherein if the current payment information conforms to the payment plan of the paperless payment file, it will execute step 3, while if the current payment information fails to conform to the payment plan of the paperless payment file, it will cease the payment.

3. making a payment according to the payment plan of the paperless payment file.

The step 1 further comprises step 1B between step 1 and step 2, which is: acquiring a verification plan of the paperless payment file and verifying the verification plan and the identity of the payer and then executing step 2 if the identity of the payer conforms to the verification plan or ceasing the payment if the identity of the payer fails to conform to the verification plan.

Before the step 1, it further comprises a step 1A: generating a paperless payment file.

The step 1A further comprises the following steps:

1A.1: establishing at least a payment plan.

1A.2 generating the paperless payment file according to the payment plan.

The step 1A.2 can be substituted by step 1A.3: establishing at least a verification plan and generating the paperless payment file according to the payment plan and the verification plan.

The present invention further provides a paperless credit limit adjustment method, comprising the following steps:

Step A1: establishing a payment plan of borrowing and a payment plan of repaying.

Step A2: authorizing the payment plan of borrowing and the payment plan of repaying.

Step A3: generating the paperless payment file according to the payment plan of borrowing and the payment plan of repaying by the generating unit.

Step A4: acquiring the payment plan of borrowing from the paperless payment files by the content acquiring unit.

Step A5: verifying if the payment plan of borrowing is authorized by the verification unit and continuing on step A6 if it is authorized. If it is not authorized, the execution will be terminated.

Step A6: executing the paperless payment file according to the payment plan of borrowing by the payment unit.

Step A7: respectively adjusting the credit limits of the identifier of the borrower and the identifier of the lender according to the payment plan by the credit unit and marking the purpose of the credit limit obtained by the identifier of the borrower according to the loan purpose recorded in the payment plan 31 of the loan.

Step A8: monitoring and controlling the use of the credit limit obtained by the borrower.

Step A9: acquiring the payment plan of repaying from the paperless payment files by the content acquiring unit.

Step A10: verifying if the payment plan of repaying is authorized by the verification unit and continuing on step A6 if it is authorized. If it is not authorized, the execution will be terminated.

Step A11: executing the paperless payment file according to the payment plan of repaying by the payment unit.

The present invention further provides a crowdfunding method, comprising the following steps:

Step B1: publishing a crowdfunding project through the crowdfunding center.

Step B2: establishing a corresponding paperless payment file for the crowdfunding project.

Step B3: making a payment according to the corresponding paperless payment file.

The step B2 further comprises the following steps:

Step B2.1: establishing the payment plan, wherein the payer is configured as the corresponding crowdfunding project and the payee is configured as the participants of the crowdfunding project, wherein the shares of the participants are provided as well, such that it can make payments according to the shares every time when the crowdfunding project gains profit.

Step B2.2: having each of the participants of the crowdfunding project authorize the payment plan.

Step B2.3: generating the corresponding paperless payment file.

The step B2.1 may be replaced with step B2.1″: establishing the payment plan, wherein the payer is configured as the corresponding crowdfunding project and the identifiers of the participants of the corresponding crowdfunding project and the payee is configured as the participants of the crowdfunding project, wherein the shares of the participants are provided as well, such that it can make payments according to the shares every time when the crowdfunding project gains profit.

The step B3 further comprises the following steps:

Step B3.1: detecting if the corresponding crowdfunding project has received a profit and executing step B3.2 if the corresponding crowdfunding project has received a profit or standing by if the corresponding crowdfunding project has not received a profit.

Step B3.2: acquiring the corresponding payment plan of the paperless payment file.

Step B3.3: verifying the corresponding payment plan of the paperless payment file.

Step B3.4: distributing the received profit according to the shares established in payment plan of the corresponding paperless payment file.

An advantage of the paperless payment system of the present invention is that the current payment information has to be verified with the payment plan of the paperless payment file when the paperless payment file is utilized to make a payment. If the current payment information does not conform to the payment plan of the paperless payment file, then it cannot make the payment. This way of controlling the fund flow at the outlet can avoid the fund from being utilized for other purposes. Besides, the use of the paperless payment system does not require credit check, which lowers the payment cost. The user only has to provide his/her identity to utilize the paperless payment system to make payments, which is simple and convenient. Besides, by using the paperless payment system of the present invention, the merchant can implement all kinds of coupons to the users by means of the paperless payment file. The user does not have to carry all kinds of coupons and discount cards therewith. The identifier of the user can be open to the public, such that the merchants may establish corresponding discount paperless payment file according to the identifier of the user. It avoids the bothers of managing the coupons and discount cards for the user. The user in the paperless payment system of the present invention can have a preset credit limit without credit check, which lowers the payment cost. The paperless payment system of the present invention further provides the crowdfunding method through the paperless payment file, such that user who is deficient in capital may utilize it to start a business. It lowers the threshold of starting a business. Besides, every profit that the crowdfunding project gains will be distributed according to the shares of the participants arranged in the payment plan of the paperless payment file of the crowdfunding project through the payment center. The paying process runs through the payment center only, which does not have to go through a third party.

When the user is editing the payment plan of the paperless payment file, the tax center will reveal and prompt the payable taxation of the user according to the payment purpose and payment limit established in the payment plan. The user can configure the payable taxation in the payment plan as well. The generation center generates the paperless payment file according to the payment plan. When the paperless payment file is utilized to make a payment, the payment center will also pay taxes according to the configured payable taxation. If the paperless payment file does not include a taxation payment, the tax center will determine if the payment of the paperless payment file has to pay tax based on the tax rules. If it has to, the tax center will make the corresponding payable taxation when the paperless payment file is utilized based on the tax rules.

The accounting management module of the paperless payment system of the present invention records the payment statuses on the identifiers of the payer and the payee respectively according to the payment status receipt and inputs them into corresponding accounting items according to accounting provisions. The accounting management module can process the expenses and receipts of the user according to accounting requirements, so as to achieve the accounting function.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a structural diagram of the paperless payment system according to a preferred embodiment of the present invention.

FIG. 2 is a flow diagram of a crowdfunding method of the paperless payment system according to the above preferred embodiment of the present invention.

FIG. 3 is a perspective view of a payment scene of the paperless payment system according to the above preferred embodiment of the present invention.

FIGS. 4-5 are perspective views of a payment scene of the paperless payment system according to another preferred embodiment of the present invention.

FIG. 6 is a flow diagram of a paperless credit limit adjustment method of the paperless payment system according to the above preferred embodiment of the present invention.

FIG. 7 is a flow diagram of a method of paperless payment of the paperless payment system according to the present invention.

### DETAILED DESCRIPTION OF THE PREFERRED EMBODIMENT

The following is disclosed in order that those skilled in the art can implement the present invention. Preferred embodiments in the following descriptions are to give examples only. Those skilled in the art can think of other obvious modifications. The basic notions of the present invention defined in the following descriptions can apply to other implementations, modifications, improvements, equivalences, and other technical solutions that do not deviate from the scope or spirit of the present invention.

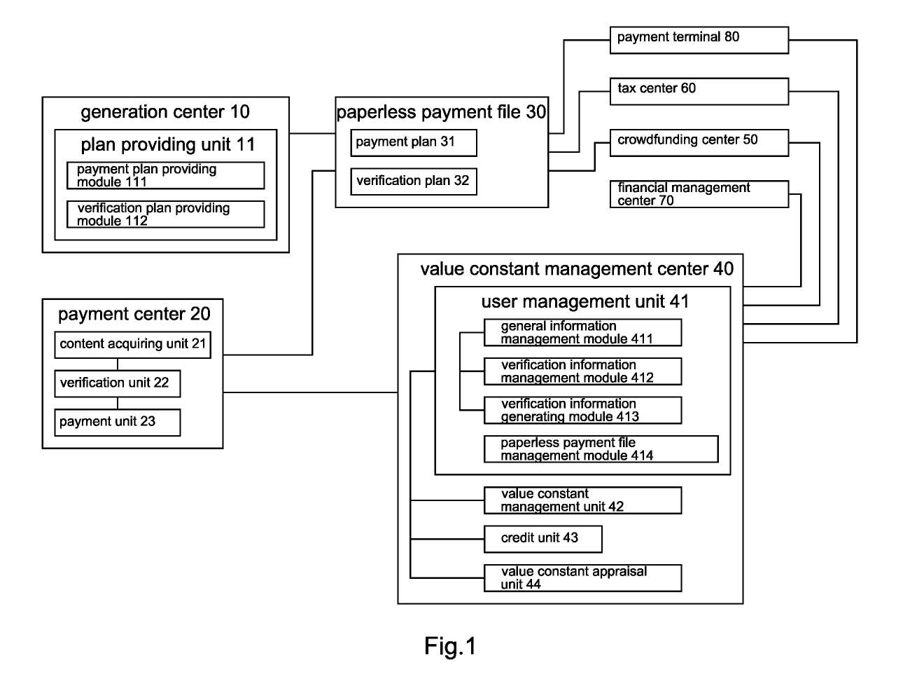

The technology of present invention, according to the disclosed content of the specification and claims, specifically includes the following. FIG. 1 illustrates a structural diagram of the paperless payment system according to a preferred embodiment of the present invention. The paperless payment system of the present invention comprises a generation center 10 and a payment center 20. The generation center 10 communicates and connects with the payment center 20. The generation center 10 is for presetting at least a payment plan 31 and generating a paperless payment file 30 according to the preset payment plan 31, so as to allow the paperless payment file 30 to be utilized for paying. When the paperless payment file 30 is utilized to make a payment, the payment center 20 will acquire the preset payment plan 31 of the paperless payment file 30 and verifies it. If the preset payment plan 31 of the paperless payment file 30 passes the verification, the payment center 20 will make the payment. The paperless payment file 30 can be applied in smart devices, such as computers, laptops, smart phones, smart watches, smart classes, smart bracelets, and etc. The paperless payment file 30 can be transmitted to a smart device through a communication network, so as for utilizing the paperless payment file 30 through the smart device.

The generation center 10 further comprises a plan providing unit 11 and a generating unit 12. The plan providing unit 11 communicates and connects with the generating unit 12. The plan providing unit 11 provides the payment plan 31. The payment plan 31 includes a preset payment limit, a preset payment purpose, a preset payment time, a preset payment location, a preset payer, a preset payee, and a preset payment terminal. The preset payment limit refers to the payment limit provided by the paperless payment file 30. The payment purpose refers to the use of the payment, such as shopping, house rent, deposit, etc., for the preset payment limit. If the preset payment purpose has been edited, the payment center 20 will verify if the preset payment purpose matches the current payment purpose when the paperless payment file 30 is utilized to make a payment. If the preset payment purpose is different from the current payment purpose, the payment center 20 will reject to make the payment with the paperless payment file 30. The preset payment time refers to that the paperless payment file 30 may only make the payment at a preset time or during a preset period. The paperless payment file 30 may not be utilized to make a payment out of the preset payment time. The preset payment location refers to the location or area to use the paperless payment file 30. The paperless payment file 30 may not be utilized to make a payment if the payment occurs out of the preset payment location. The preset payer refers to the person utilizing the paperless payment file 30 to make the payment. The payment center 20 will verify if the current payer is the preset payer when the paperless payment file 30 is utilized to make the payment. If the current payer is different from the preset payer, the current payer will not be allowed to utilize the paperless payment file 30 to make the payment. It is worth mentioning that the preset payer can be preset to be one or more payers. If the preset payer refers to multiple payers, the payers will share the payment limit. The preset payee refers to the payee of the paperless payment file 30. If the preset payee is not the current payee, the payment will be ceased. The preset payment terminal refers to that the paperless payment file 30 is bound to a preset payment terminal. The payment center 20 will make the payment only when the paperless payment file 30 is utilized through the preset payment terminal. In other words, the paperless payment file 30 may not be utilized to make the payment through other payment terminal. It is worth mentioning that the plan providing unit 11 can be configured to forbid or allow cancellation of the payment plan 31. If the payment plan 31 is configured to allow cancellation or change, the payment plan 31 may both be cancelled or modified before it is used. If the payment plan 31 is used or being used, the payment plan 31 may not be cancelled or changed.

When the setup of the payment plan 31 is completed, the payment plan 31 of the paperless payment file 30 will be sent to the generating unit 12 by the plan providing unit 11. The generating unit 12 will generate the paperless payment file 30 according to the provided payment plan 31 by means of encoding or encrypting. The paperless payment file 30 can be revealed as a payment code, such as QR code, two-dimensional time code, three-dimensional code or three-dimensional time code, and etc. The two-dimensional time code refers to that the QR code allowing a time record), such as recording the generated time, the payment time, the receiving time, and etc. of the QR code, be added thereon. The three-dimensional code refers to that the payment code can be presented in a three-dimensional form, so as to carry more content of the payment. The three-dimensional time code refers to that the three-dimensional code further allowing the generated time, the payment time, the receiving time, and etc. to be recorded. It is worth mentioning that the paperless payment file 30 can also be presented in the form of a 5 second or shorter video clip. That is to say, the generating unit 12 generates a second or shorter video clip according to the content of the payment by means of encoding or encrypting. Preferably, the generating unit 12 generates a one second long video clip according to the content of the payment by means of encoding or encrypting. The paperless payment file 30 may also be presented as a picture.

The payment center 20 further comprises a content acquiring unit 21, a verification unit 22, and a payment unit 23 communicating and connecting with one another. When the paperless payment file 30 is utilized to make a payment, the content acquiring unit 21 will acquire the content of the payment plan 31 of the paperless payment file 30 and send it to the verification unit 22. In addition, the content acquiring unit 21 may further acquire the current payment information, such as current payment purpose, current payment location, current payment time, current payment limit, and etc. Then the content acquiring unit 21 will send the acquired current payment information to the verification unit 22. The verification unit 22 will verify the current payment information and the content of the payment plan 31 of the paperless payment file 30. If the current payment information conforms to the content of the payment plan 11 of the paperless payment file 30, the verification unit 22 will send a message of payment confirmation to the payment unit 23. The payment unit 23 will make the payment after receiving the message of payment confirmation. If the current payment information does not conform to the preset payment content of the paperless payment file 30, the verification unit 22 will send a message of payment termination to the payment unit 23. The payment unit 23 will cancel the payment after receiving the message of payment termination.

It is worth mentioning that the plan providing unit 11 may have a preset verification content for verifying the identity of the payer who is utilizing the paperless payment file 30. The plan providing unit 11 further comprises a payment plan providing module 111 and a verification plan providing module 112. The payment plan providing module 111 communicates and connects with the verification plan providing module 112. The payment plan providing module 111 is for providing the payment plan 31. The verification plan providing module 112 is adaptable to provide at least a verification plan 32 for identifying the user of the paperless payment file. The verification plan 32 allows biological features of the user, such as the fingerprint, palm print, pupil, pupil distance, voice print, face, phalanges, skull, and etc., to be established and configured therein. The verification plan 32 may further comprise a verification action configured therein. For example, the payer may conduct an action when holding a smart device that has a gyroscope arranged therein. Then the verification plan providing module 112 can record the information of the action of the user through the gyroscope. The verification plan providing module 112 allows one or more of the biological features and/or verification actions to be selected and utilized for the verification plan 32 when establishing the verification plan 32. The paperless payment file 30 comprises the payment plan 31 and the verification plan 32.

The generation center 10 further comprises an authorization unit 13 communicating and connecting with the plan providing unit 11 and the generating unit 12 respectively. The plan providing unit 11 will send the payment plan 31 of the paperless payment file 30 to the authorization unit 13 as the preset content of the paperless payment file 30 is established and provided. An authorizing person may utilize the authorization unit 13 to review and verify the payment plan 31 of the paperless payment file 30. Once the authorizing person has passed the payment plan 31 of the paperless payment file 30, the authorization unit 13 will send the payment plan 31 of the paperless payment file 30 to the generating unit 12. Then the generating unit 12 generates corresponding paperless payment file 30 according to the payment plan 31 of the paperless payment file 30. It is worth mentioning that the preset content of the paperless payment file 30 does not have to be edited by the payer in person through the authorization unit 13. Instead, it may also be assisted or edited through others. In that case, the payer only has to verify and authorize the content, which makes the use of the paperless payment file much flexible.

If the paperless payment file 30 includes the payment plan 31 and the verification plan 32, the verification unit 22 of the payment center 20 must verify the payment plan 31 and the verification plan 32. The payment unit 23 will make the payment according to the payment plan 31 of the paperless payment file 30 when the payment plan 31 and the verification plan 32 of the paperless payment file 30 are both verified.

The paperless payment system further comprises a value constant management center 40. The value constant management center 40 is respectively communicated and connected with the generation center 10 and the payment center 20. The value constant management center 40 is for managing the value constant owned by the user. The value constant refers to a constant, such as π, and etc. Preferably, the paperless payment system of the present invention utilizes the value constant to make the payment. The value constant management center 40 further comprises a user management unit 41 and a value constant management unit 42. Preferably, the user management unit 41 assigns each user a corresponding identifier 4111, so as for identifying each user. The user management unit 41 utilizes the identifier to manage corresponding information of the user. Preferably, the identifier 4111 can be open to the public. Preferably, the identifier 4111 can be changed. The value constant management unit 42 utilizes the identifier 4111 to manage corresponding value constant limit of the user. For example, the value constant of a user corresponded to an identifier 4111 can be increased, the value constant of a user corresponded to an identifier 4111 can be decreased, the value constant of an identifier 4111 can be transferred to the value constant of another identifier 4111, and etc. It is worth mentioning that the paperless payment system of the present invention is logged on with the user's biological feature. The biological feature includes fingerprint, intraocular distance, retina, voice print, face, and etc. The user may setup and utilize one or more of the biological features for logging on the system. Preferably, the paperless payment system of the present invention does not record password. When the user is logging on with biological feature, the verification unit 22 will examine and verify the biological feature of the user and generate a verification code based on the biological feature of the user. Besides, the user management unit 41 will generate a second verification code. The user management unit 41 will send the second verification code to the verification unit 22 so as to be matched with the verification code. If these two verification codes match, the user will be allowed to log on the system. Otherwise, the user cannot log on the system. It is worth mentioning that the information of the user recorded in the user management unit 41 is encrypted. The use of the individual information of a user can only be authorized when the user is identified.

The user management unit 41 further includes a general information management module 411 and a verification information management module 412. The general information management module 411 manages the general information of the user, which includes data like name, age, educational background, work history, and etc. The verification information management module 412 is for managing the verification information of the user, such as the biological features or verification action corresponded to the user. The user management unit 41 is communicated and connected with the plan providing unit 11 for providing verification information of the corresponded user for establishing the verification plan 32. The plan providing unit 11 picks up verification information for establishing the verification plan 32 from the verification information management module 412. The user management unit 41 further includes a verification information generating module 413. The verification information generating module 413 is respectively communicated and connected with the verification unit 22, the general information management module 411, and the verification information management module 412. When the user is logging on, the verification unit 22 will examine and verify the biological feature of the user and generate the verification code based on the biological feature of the user. The verification information generating module 413 can acquire general information and verification information corresponded to the user from the general information management module 411 and/or the verification information management module 412. The verification information generating module 413 generates a second verification code according to the general information and verification information corresponded to the user. The verification unit 22 matched the verification code with the second verification code. If the verification codes match with each other, the user will be allowed to log on the system. If the verification codes do not match with each other, the user will not be allowed to log on the system.

The verification information generating module 413 is further communicated and connected with the plan providing unit 11. The verification information generating module 413 can acquire general information and verification information corresponded to the user from the general information management module 411 and the verification information management module 412 respectively. Then the verification information generating module 413 will respectively extract part of the general information corresponded to the user and part of the verification information corresponded to the user and edit the extracted part of the general information and verification information of the user to generate a verification content 4131. The verification plan providing module 112 of the plan providing unit 11 acquires the verification content 4131 from the generating unit 413 for establishing the verification plan 32. For instance, the verification information 413 can respectively acquire the educational background information from the general information corresponded to the user and the intraocular distance information of the user from the verification information corresponded to the user, and then generate a verification information corresponded to the user with the educational background information and the intraocular distance information of the user. The verification information 413 1 corresponded to the user will then be transmitted to the plan providing unit 11. The verification plan providing module 112 of the plan providing unit 11 establishes and provides the verification plan 32 of the paperless payment file 30 according to the verification information 4131 corresponded to the user. The verification unit 22 of the payment center 20 conducts verification based on the verification plan 32 when the paperless payment file 30 is utilized to make the payment. If it passes the verification, the payment center 23 will respectively transmit the identifier 4111 of the payer, the identifier 4111 of the payee, and the payment limit to the value constant management unit 42. The value constant management unit 42 will then transfer the value constant of the amount equal to the payment limit from the identifier 4111 of the payer to the identifier 4111 of the payee.

It is worth mentioning that the verification information management module 412 may allow at least an emergent verification plan 4121 be set. The emergent verification plan 4121 refers to an emergent verification plan 4121 available for the user to use in case of emergency. The emergency includes being threatened, having accident, requiring urgent help, in danger of life, and etc. The verification unit 22 will call the police when receiving the emergent verification plan 4121, so as to inform the police that the user encounters emergency. For example, the user may assign his/her emergent verification plan to be verification with fingerprint of his/her ring finger. Once the user is using the paperless payment file and threatened, she/he can then utilize fingerprint of his/her ring finger at the verification. When the verification unit 22 receives fingerprint of the ring finger of the user for verification, the verification unit 22 will execute the emergent verification plan 4121 of the user: to call the police. It is worth mentioning that the emergent verification plan 4121 may also be configured to be a two-step verification, so as to prevent misoperation. For instance, when the user utilizes fingerprint of his/her ring finger for verification, once the verification unit 22 receives it, the verification unit 22 will start the emergent verification plan 4121 of the user: to ask for verification again. The verification unit 22 prompts the request to ask the user to conduct the verification again. If the user utilize fingerprint of his/her ring finger for verification again, the verification unit 22 will execute the emergent verification plan 4121: to call the police. If the user utilize fingerprint of other finger for verification, the verification unit 22 will call off the execution of the emergent verification plan 4121 and execute the paying operation.

The user management unit 41 further comprises a paperless payment file management module 414 communicating and connecting with the generation center 10, so as for the generating unit 13 to receive the paperless payment file 30. The paperless payment file management module is for the user to manage his/her own paperless payment file 30. The value constant management center 40 further comprises a value constant appraisal unit 44 communicated and connected with the general information management module 411 of the user management unit 41 for acquiring the general information of the user. The value constant appraisal unit 44 appraises the value constant factor “a” of the user based on the general information of the user. The value constant appraisal unit 44 acquires the time “h” spent by the user for completing a job or providing a service through connecting to an external metering device and, therefore, determines that the value constant (VC) that the user should obtain from that job equals to “a” times “h” (VC=ah).

The value constant management center 40 further comprises a credit unit 43 communicating and connecting with the user management unit 41, the value constant management unit 42, the generation center 10, and the payment center 20 respectively. The credit unit 43 establishes a preset credit limit according to the identifier 4111. Preferably, the credit limit is in value constant. The preset credit limit is adjusted through the credit unit 43. Preferably, the credit unit 43 presets the same amount of credit limit for each user. The credit limit can be utilized to make the payment. Preferably, the credit limit is in value constant. When the preset credit limit of the user is used up, the credit unit 43 will lock the identifier 4111 of the user so as to forbid the user from paying with credit limit. When the credit unit 43 receives a paid back value constant in the amount equals to the credit limit from the user, the credit unit 43 will unlock the user's account so as to allow the user to keep utilizing the credit limit to make the payment.

After the identifier 4111 of the user is established, the credit unit 43 will establish the credit limit of the user according to the identifier 4111 of the user. The credit limit established and provided by the credit unit 43 is in value constant. Preferably, the credit unit 43 presets the same amount of credit limit for each user. Further, the credit unit 43 acquires the general information of the user from the general information management module 411 of the user management unit 41. Then the credit unit 43 will adjust the credit limit of the user based on the general information of the user. The credit unit 43 monitors the credit limit of each user. When the credit limit of the user is used up, the credit unit 43 will lock the identifier 4111 of the user so as to stop the identifier 4111 from paying with the credit limit of the user. When the user pays back a value constant in the amount equals to the credit limit, the credit unit 43 will unlock his/her identifier 4111 so as to allow the identifier 4111 to keep utilizing the credit limit to make the payment.

It is worth mentioning that the credit unit 43 may adjust the credit limit of the user based on a amount of value constant equal to a collateral of the user, such that the user may utilize the amount of value constant equal to the collateral to make the payment. Specifically speaking, the value constant limit of the collateral of the user has to be appraised. Then the credit unit 43 may adjust the credit limit of the user accordingly. The value constant limit of the collateral of the user will be added to the credit limit of the user, so as to increase the credit limit of the user.

The credit unit 43 is also for adjusting the credit limits among the users. If the credit limit of the user is insufficient to make the payment, the user may also borrow credit limit from another user through the credit unit 43. The user may provide the paperless payment file 30 and send it to another user. The second user can review the paperless payment file 30 and execute the paperless payment file 30 if s/he agrees. Then the credit unit 43 will be executed according to the payment plan 31 of the paperless payment file 30. Specifically speaking, the user established the payment plan 31 through the plan providing unit 11 of the generation center 10. For example, the user establishes two payment plans 31 through the plan providing unit 11, wherein one of the payment plan 31 is a borrowing plan, while the other payment plan 31 is a repaying plan. In the borrowing plan, the first user configures the payer as the identifier 4111 of the second user and the payee as the identifier 4111 of the first user. Then the first user further configures the borrowing limit, time to receive the loan, purpose of the loan, and etc. In the other payment plan 31, the repaying plan is configured. In the repaying plan, it can be configured as a repaying in full or installments. It can also include the amount of value constant of each installment. The payer is configured as the identifier 4111 of the first user, while the payee is configured as the identifier 4111 of the second user. Then these two payment plans 31 will be transmitted to the authorization unit 13. The second user reviews the two payment plans 31 through the authorization unit 13. If the second user approves the two payment plans 31, the two payment plans 31 will be authorized through the authorization unit 13. When these two payment plans 31 are authorized by both users, these two payment plans 31 will be sent to the generating unit 12. Then the generating unit 12 will generate the paperless payment file 30 according to these two payment plans 31. Then the paperless payment file 30 will be sent to the payment center 20.

The payment center 20 will make the payment according to the two payment plan 31 of the paperless payment file 30. The content acquiring unit 21 acquires the content of the payment plan 31. The payment plan 31 is the borrowing plan. The content of the payment plan 31 will be sent to the verification unit 22. The verification unit 22 will verify the content of the payment plan 31, the authorization of the user, and the authorization of the second user. If verified, the content of the payment plan 31 will be transmitted to the payment unit 31. The payment unit 23 will execute the payment according to the payment plan 31. The payment unit 23 will transmit the content of the payment plan 31 to the credit unit 43. The credit unit 43 will, according to the content of the payment plan 31, deduct the amount of credit configured in the payment plan 31 from the credit limit of the second user and add it into the credit limit of the user configured in the payment plan 31. It is worth mentioning that the credit unit 43 will mark the credit limit obtained by the user, such that the obtained credit limit may only be utilized on the purposes recorded in the payment plan 31. In other words, when the user utilizes the paperless payment file 30 to make the payment, if the use of the payment configured in the payment plan 31 of the paperless payment file 30 does not conform to the purposes of the loan, the payment unit 23 will be unable to use that marked loan of the user to make the payment, so as to ensure that the loan will be spent for the marked purposes. If the use of the payment configured in the payment plan 31 of the paperless payment file 30 conforms to the purposes of the loan, the payment unit 23 may use that marked loan of the user to make the payment. The credit unit 43 will deduct payment limit from the marked credit limit of the identifier 4111. When the loan is repaid, the payment unit 23 will be executed according to the other payment plan 31 of the paperless payment file 30. If the other payment plan 31 is configured to be repaid in installments, the payment unit 23 will be automatically executed in the assigned dates to make the repayments. It is worth mentioning that if the user has repaid off the loan, but has not used up the loan, the credit unit 43 will remove the mark of the loan, such that the loan may be utilized for other purposes.

It is worth mentioning that the user may also borrow from a plurality of users through the credit unit 43. The user establishes a paperless payment file 30 to borrow from a first user, but the credit limit of the first user is insufficient for the loan. Therefore, the user establishes another paperless payment file 30 to borrow from a second user. If the credit limit of the second user is insufficient for the loan of the user, s/he could continue to borrow from a third user. In the end, the borrowing need of the user can be fully satisfied.

When the user utilizes the loan, the payment center 20 will match the current payment purpose of the user to the paperless payment file 30. The payment center 20 will make the payment according to the payment plan 31 of one of the paperless payment file 30 if the payment plan 31 of the paperless payment file 30 matches the current payment purpose. Specifically speaking, the content acquiring unit 21 will acquire the current payment purpose. The content acquiring unit 21 respectively acquires the payment plans 31 from all of the paperless payment files 30. The verification unit 22 respectively verifies the current payment purpose of the user with the payment plans 31 of all the paperless payment files 30. The payment unit 23 will make the payment according to the payment plan 31 of one of the paperless payment file 30 if the payment plan 31 of the paperless payment file 30 matches the current payment purpose. In this way, the use of the loan can be controlled, so as to protect the interests of the lender.

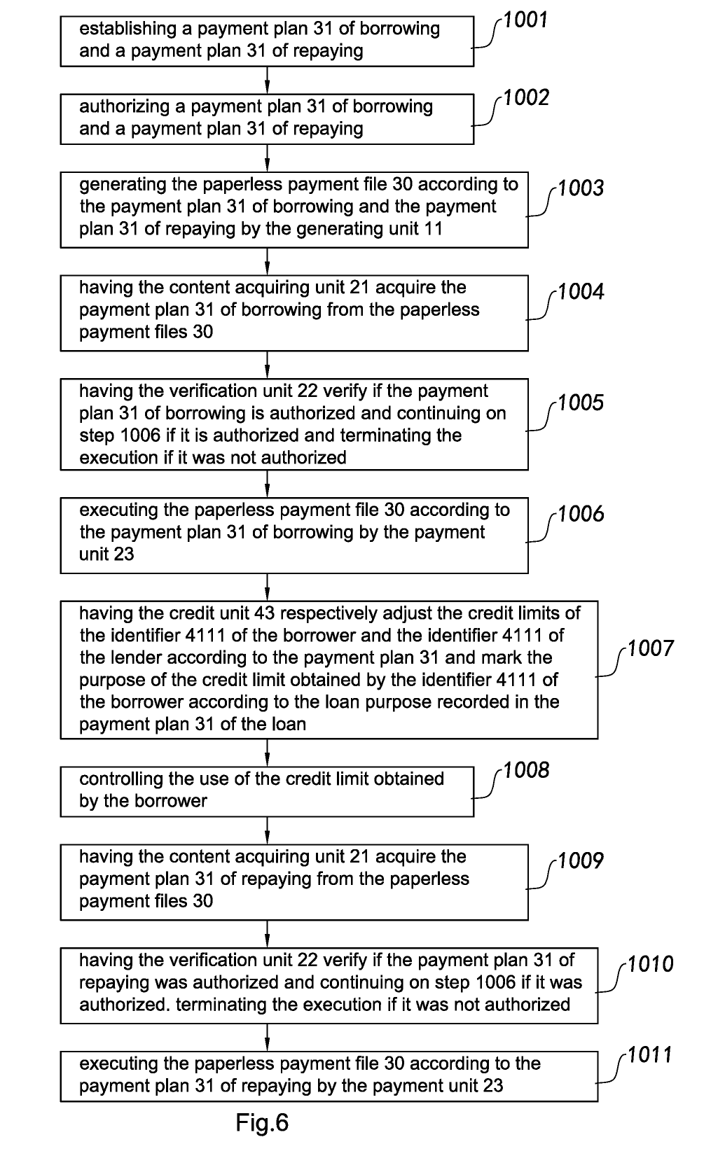

FIG. 6 is a flow diagram of a paperless credit limit adjustment method of the paperless payment system according to a preferred embodiment of the present invention.

The present invention further provides a paperless credit limit adjustment method, comprising the following steps:

Step 1001: establishing a payment plan 31 of borrowing and a payment plan 31 of repaying.

It establishes at least two payment plans 31 through the plan providing unit 11, wherein one of the payment plan 31 is a payment plan 31 of borrowing, while the other payment plan 31 is a payment plan 31 of repaying.

Step 1002: authorizing the payment plan 31 of borrowing and the payment plan 31 of repaying.

The borrower and the lender respectively examine and verify the payment plan 31 of borrowing and the payment plan 31 of repaying through the authorization unit. If both the borrower and the lender pass the payment plan 31 of borrowing and the payment plan 31 of repaying, the borrower and the lender will respectively authorize the payment plan 31 of borrowing and the payment plan 31 of repaying.

Step 1003: generating the paperless payment file 30 according to the payment plan 31 of borrowing and the payment plan 31 of repaying by the generating unit 11.

Step 1004: acquiring the payment plan 31 of borrowing from the paperless payment files 30 by the content acquiring unit 21.

Step 1005: verifying if the payment plan 31 of borrowing is authorized by the verification unit 22 and continuing on step 1006 if it is authorized. If it is not authorized, the execution will be terminated.

Step 1006: executing the paperless payment file 30 according to the payment plan 31 of borrowing by the payment unit 23.

Step 1007: respectively adjusting the credit limits of the identifier 4111 of the borrower and the identifier 4111 of the lender according to the payment plan 31 by the credit unit 43 and marking the purpose of the credit limit obtained by the identifier 4111 of the borrower according to the loan purpose recorded in the payment plan 31 of the loan.

The credit unit 43 adds the amount of credit limit configured in the payment plan 31 of the loan into the credit limit corresponded to the identifier 4111 of the borrower according to the credit limit configured in the payment plan 31 of the loan. Then it will mark the loan purpose recorded in the payment plan 31 of the loan on the added credit limit be under the identifier 4111 of the borrower, such that the borrowed credit limit of the borrower may only be utilized in the marked purpose. The credit unit 43 also deducts the amount of credit limit configured in the payment plan 31 of the loan from the credit limit corresponded to the identifier 4111 of the lender according to the credit limit configured in the payment plan 31 of the loan.

Step 1008: monitoring and controlling the use of the credit limit obtained by the borrower.

When the borrower utilize the obtained credit limit through the paperless payment file 30, the verification unit 22 will verify if the use of the payment configured in the payment plan 31 of the paperless payment file 30 conforms to the purpose marked on the obtained credit limit. If it does, then the payment unit 23 will make the payment according to the payment plan 31 of the paperless payment file 30. If it does not, then the payment unit 23 will cease the payment.

Step 1009: acquiring the payment plan 31 of repaying from the paperless payment files 30 by the content acquiring unit 21.

Step 1010: verifying if the payment plan 31 of repaying is authorized by the verification unit 22 and continuing on step 1006 if it is authorized. If it is not authorized, the execution will be terminated.

Step 1011: executing the paperless payment file 30 according to the payment plan 31 of repaying by the payment unit 23.

If the payment plan 31 of repaying is configured as repaying in full, the payment unit 23 will respectively adjust the value constant limits of the identifiers 4111 of the borrower and the lender through the value constant management unit 42 accordingly. The value constant management unit 42 decreases the amount of repaying from the value constant limit of the identifier 4111 of the borrower and increases the amount of repaying to the value constant limit of the identifier 4111 of the lender. If the payment plan 31 of repaying is configured as repaying in installments, the payment unit 23 will respectively adjust the value constant limits of the identifiers 4111 of the borrower and the lender through the value constant management unit 42 accordingly when it is the time to repay. It is worth mentioning that the payment plan 31 of repaying can be configured to repay in accordance with each income of the identifier 4111 of the borrower. For instance, the proportion for repaying from each income of the identifier 4111 of the borrower can be configured in the payment plan 31 of repaying. The payment unit 23 detects the identifier 4111 of the borrower through the value constant management unit 42. When the identifier 4111 of the borrower has received an income, the value constant management unit 42 will adjust the value constant limits of the identifiers 4111 of the borrower and the lender respectively according to the proportion for repaying configured in the payment plan 31 of repaying.

It is worth mentioning that the borrower can determine the quantity of the lender based on the requiring amount of the value unit of borrowing and establish corresponding paperless payment files 30 respectively.

The paperless payment system of the present invention further provides a crowdfunding center 50. The crowdfunding center 50 is respectively communicated and connected with the generation center 10, the payment center 20, and the value constant management center 40. The user may publish at least a crowdfunding project 51 at the crowdfunding center 50. Preferably, the crowdfunding center 50 manage the crowdfunding project 51 published by the user through the corresponding identifier 41111 of the user.

The participants of the crowdfunding project 51 generate the paperless payment file 30 of the crowdfunding project 51 through the generation center 10. The shares of the participants are provided in the payment plan 31 of the paperless payment file 30 of the crowdfunding project 51. In other words, when the crowdfunding project 51 gains a profit, the profit obtained will be distributed according to the shares established in the payment plan 31 of the paperless payment file 30 of the crowdfunding project 51. Preferably, every time when the crowdfunding project 51 gains a profit, the profit obtained will be directly distributed according to the shares established in the payment plan 31 of the paperless payment file 30 of the crowdfunding project 51. The “directly” means that every profit that the crowdfunding project 51 gains will make the payment through the payment center 20 according to the payment plan 31 of the paperless payment file 30 of the crowdfunding project 51. It does not require going through a third party. Specifically speaking, the payment plan 31 is established and provided through the plan providing unit 11, wherein the payer is configured as the crowdfunding project 51 and the payee is configured as the participants of the crowdfunding project 51. The payment plan 31 further allows the shares of the participants to be established and configured. The generating unit 12 will generate the paperless payment file 30 of the crowdfunding project 51 according to the payment plan 31. It is worth mentioning that the payment plan can be transmitted to the authorization unit 13, where the participants may edit the payment plan 31 therethrough. When the payment plan 31 is authorized by the participants respectively, the payment plan 31 will be sent to the generation center 12. If the verification unit 22 of the payment center 20 detects that one of the payees of the payment plan 31 of the paperless payment file 30 is the crowdfunding project 51, the payment center 20 will execute the paperless payment file 30 of the crowdfunding project 51. The payment unit 23 will utilize the value constant limit paid to the crowdfunding project 51 to make payments according to the paperless payment file 30 of the crowdfunding project 51. In other words, the payment unit 23 will utilize the value constant limit paid to the crowdfunding project 51 to make payments according to the shares of the participants provided in the payment plan 31 of the paperless payment file 30 of the crowdfunding project 51. The participants of the crowdfunding project 51 respectively obtain value constant limits of the corresponding proportion.

It is worth mentioning that the crowdfunding center 50 provides another management mode of the crowdfunding project 51. After the crowdfunding project 51 is published in the crowdfunding center 50, the value constant management center 40 will establish a corresponding crowdfunding project identifier 5111, so as for the value constant management center 40 to manage the crowdfunding project 51. The value constant obtained from the crowdfunding project 51 will be managed with the crowdfunding project 5111. When the value constant management unit 42 of the value constant management center 40 detects the crowdfunding project 51 through the crowdfunding project identifier 5111, the payment center 20 will execute the paperless payment file 30 of the crowdfunding project 51. The payment unit 23 will utilize the value constant limit paid to the crowdfunding project 51 to make payments according to the shares of the participants provided in the payment plan 31 of the paperless payment file 30 of the crowdfunding project 51. Preferably, the payment center 20 makes payments according to the paperless payment file 30 of the crowdfunding project 51 and the crowdfunding project identifier 5111 when the crowdfunding project 51 obtains a profit.

For example, the user may publish a crowdfunding project 51 of a coffee shop in the crowdfunding center 50. The user is a barista, so he utilizes the crowdfunding center 50 to publish resources that the crowdfunding coffee shop lacks, such as a store, materials, a waiter, a pastry chef, and etc. A second user can be a landlord who is able to provide a store for the coffee shop. A third user can be a material supplier. A fourth user can be a waiter. A fifth user can be a pastry chef. The user establishes the payment plan 31 through the plan providing unit 11. The payer is the crowdfunding project 51 of the coffee shop and the payees are respectively the user, the landlord, the material supplier, the waiter, and the pastry chef. The user may configure the shares and send the payment plan 31 to the authorization unit 32. The shares refer to the shares or portions of the profit that the users who have participated in the crowdfunding project deserves, such that she/he may obtain the portion of profit from each profit made from each time a merchandise is sold. The user, landlord, material supplier, waiter, and pastry chef edit the content of the payment plan 31 through the authorization unit 32. After the payees, namely, the user, the landlord, the material supplier, the waiter, and the pastry chef, have authorized it, the payment plan 31 will be transmitted to the generating unit 12. The generating unit 12 will generate the paperless payment file 30 of the coffee shop. Then the paperless payment file 30 of the coffee shop will be sent to the payment center 20. The payment center 20 makes the payment according to the paperless payment file 30 of the coffee shop.

The store of the landlord requires renovation, so the landlord may start a crowdfunding project 51 of the renovation through the crowdfunding center 50. The landlord provides the payment plan 31 through the plan providing unit 11. The payer is configured as the identifiers 4111 of the landlord and the crowdfunding project 51 of the coffee shop, while the payee is configured as the identifiers 4111 of the landlord and the renovation service provider. The shares of the profit of the landlord and the renovation service provider are preset. After the payment plan 31 has been established and provided, it will be transmitted to the authorization unit 13. The landlord and the renovation service provider edit the payment plan 31 through the authorization unit 13. The landlord and the renovation service provider respectively authorize the payment plan 31 through the authorization unit 13. The authorized payment plan 31 will be sent to the generating unit 12. The generating unit 12 will generate the paperless payment file 30 of the renovation according to the payment plan 31. The paperless payment file 30 of the renovation will be sent to the payment center 20 and the payment center 20 will make payments according to the paperless payment file 30.

The renovation service provider has to transport the renovation materials to the store of the landlord, so the renovation service provider may utilize the crowdfunding center 50 to start a crowdfunding project 51 of transportation with the identifier 4111 of the renovation service provider. The renovation service provider provides the payment plan 31 through the plan providing unit 11. The payer of the payment plan 31 is configured as the identifiers 4111 of the renovation service provider and the crowdfunding project 51 of the renovation, while the payee is configured as the identifiers 4111 of the renovation service provider and the transportation service provider. The renovation service provider established and configured the shares of the profit. Then the payment plan 31 will be transmitted to the authorization unit 13. The renovation service provider and the transportation service provider utilize the authorization unit 13 to edit the payment plan 31 and reach a consensus. After the renovation service provider and the transportation service provider authorized the payment plan 31, the payment plan 31 will be sent to the generating unit 12 by the authorization unit 13. The generating unit 12 will generate the paperless payment file 30 of the transportation according to the payment plan 31. The paperless payment file 30 of the transportation will be sent to the payment center 20 by the generating unit 12 and the payment center 20 will make payments according to the paperless payment file 30 of the transportation.

When the customer utilizes the paperless payment file 30 to buy merchandise in the coffee shop established through the crowdfunding project 51 of the coffee shop, the payment unit 20 will utilize the value constant limit paid by the customer to pay to the crowdfunding project 51 of the coffee shop. When the verification unit 22 of the payment unit 20 detects that the crowdfunding project 51 of the coffee shop has received a profit, it will trigger the content acquiring unit 21 to acquire the payment plan 31 of the paperless payment file 30 of the coffee shop and send the payment plan 31 of the paperless payment file 30 of the coffee shop to the verification unit 22. The verification unit 22 verifies the payment plan 31 of the paperless payment file 30 of the coffee shop. The payer is the crowdfunding project 51 of the coffee shop and all of the user, landlord, material supplier, waiter, and pastry chef have authorized, so the payment plan 31 of the paperless payment file 30 of the coffee shop will pass the verification. The payment unit 23 makes payments to the identifier 4111 of the user, the identifier 4111 of the landlord, the identifier 4111 of the material supplier, the identifier 4111 of the waiter, and the identifier 4111 of the pastry chef according to the shares recorded in the payment plan 31 of the paperless payment file 30 of the coffee shop.

When the verification unit 22 of the payment unit 20 detects that the identifier 4111 of the landlord has received the profit of the crowdfunding project 51 of the coffee shop, it will trigger the content acquiring unit 21 to acquire the payment plan 31 of the paperless payment file 30 of the renovation and send the payment plan 31 of the paperless payment file 30 of the renovation to the verification unit 22. The verification unit 22 verifies the payment plan 31 of the paperless payment file 30 of the renovation. The payer is the crowdfunding project 51 of the coffee shop, which is from the identifier 4111 of the landlord, and both the landlord and the renovation service provider have authorized it, so the payment plan 31 of the paperless payment file 30 will pass the verification. The payment unit 23 makes payments to the identifier 4111 of the landlord and the identifier 4111 of the renovation service provider according to shares recorded in the payment plan 31 of the paperless payment file 30 of the renovation.

When the verification unit 22 of the payment unit 20 detects that the identifier 4111 of the renovation has received the profit of the crowdfunding project 51 of the renovation, it will trigger the content acquiring unit 21 to acquire the payment plan 31 of the paperless payment file 30 of the renovation and send the payment plan 31 of the paperless payment file 30 of the transportation to the verification unit 22. The verification unit 22 verifies the payment plan 31 of the paperless payment file 30 of the transportation. The payer is the crowdfunding project 51 of the renovation, which is from the identifier 4111 of the renovation service provider, and both the renovation service provider and the transportation service provider have authorized it, so the payment plan 31 of the paperless payment file 30 will pass the verification. The payment unit 23 makes payments to the identifier 4111 of the transportation service provider and the identifier 4111 of the renovation service provider according to shares recorded in the payment plan 31 of the paperless payment file 30 of the transportation.

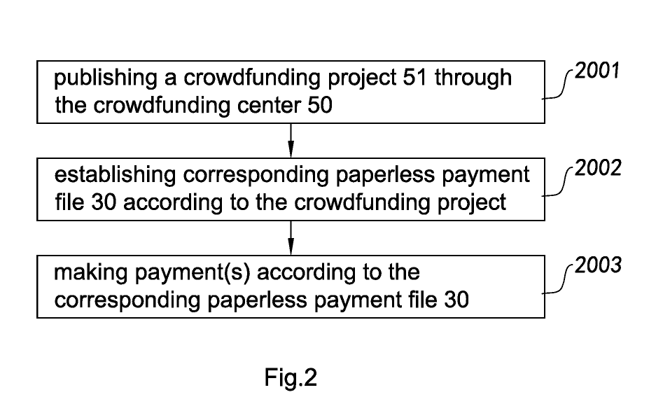

FIG. 2 illustrates a flow diagram of the crowdfunding method according to a preferred embodiment of the present invention.

The crowdfunding method of the present invention comprises the following steps:

Step 2001: publishing a crowdfunding project 51 through the crowdfunding center 50.

Step 2002: establishing corresponding paperless payment file 30 according to the crowdfunding project 51.

Step 2003: making the payment according to the corresponding paperless payment file 30.

The step 2002 further comprises the following steps:

Step 20021: establishing the payment plan 31, wherein the payer is configured as the corresponding crowdfunding project 51 and the payee is configured as the participants of the crowdfunding project 51, wherein the shares of the participants are provided as well, such that it can make payments according to the shares when the crowdfunding project 51 gains profit.

Step 20022: authorizing the payment plan 31 by each of the participants of the crowdfunding project 51.

Step 20023: generating the corresponding paperless payment file 30.

The step 20021 may be replaced with step 20021′: establishing the payment plan 31, wherein the payer is configured as the corresponding crowdfunding project 51 and the identifiers 4111 of the participants of the corresponding crowdfunding project and the payee is configured as the participants of the crowdfunding project 51, wherein the shares of the participants are provided as well, such that it can make payments according to the shares when the crowdfunding project 51 gains profit.

The step 2003 further comprises the following steps:

Step 20031: detecting if the corresponding crowdfunding project 51 has received a profit and executing step 20031 if the corresponding crowdfunding project 51 has received a profit or standing by if the corresponding crowdfunding project 51 has not received a profit.

Step 20032: acquiring the corresponding payment plan 31 of the paperless payment file 30.

Step 20033: verifying the corresponding payment plan 31 of the paperless payment file 30.

Step 20034: distributing the received profit according to the shares established in payment plan 31 of the corresponding paperless payment file 30.

The step 20031 can be substituted by step 20031′: detecting if the corresponding crowdfunding project 51 has received a profit from the identifier 4111 of the participant of the corresponding crowdfunding project 51 and executing step 20032 if so or standing by if the corresponding crowdfunding project has not received the profit.

Preferably, every profit that the crowdfunding project 51 gains directly makes payment by the payment center 20 according to the payment plan 31 of the paperless payment file 30 of the crowdfunding project 51. Hence the paperless payment system according to the present invention does not have to work through a third party

The paperless payment system of the present invention further comprises a tax center 60. The tax center 60 is respectively communicated and connected with the crowdfunding center 50, the generation center 10, the payment center 20, and the value constant management center 40. The tax center 60 allows at least a set of tax rules to be established and configured, such that the tax center 60 will collect taxes based on the set of configured tax rules. For example, when the user is shopping, he may utilize the paperless payment file 30 to buy goods. Then the tax center 60 will determine if the current payment has to pay tax based on the tax rules. If it has to, the tax center 60 will send a paperless payment file 30 of tax to the payment center 20 when the payment center 20 is processing the current payment, so as to ask the payment center 20 for the tax payment. After the payment center 20 received the paperless payment file 30 of duty, it will pay the tax according to the paperless payment file 30 of duty. It is worth mentioning that the tax center 60 can provide a taxation estimate in the establishing step of the paperless payment file. The user has to authorize the tax center 60 to access the plan providing unit 11 when the user is establishing the paperless payment file 30. When the user input the use of the payment and the amount of the payment, the tax center 60 will estimate the required taxation based on the use of the payment and the amount of the payment, so as for the user to configure the payable taxation into the payment plan as well. Preferably, the tax center manages the user's taxation according to the corresponding identifier 5111 of the user.

It is worth mentioning that when establishing the paperless payment file 30 of the crowdfunding project 51, the tax center 60 will reveal the proportion of payable taxation of each of the profit gain by the crowdfunding project 51 based on the tax rules. The payable tax rates of the crowdfunding project 51 and the participants are configured in the payment plan 31 of the paperless payment file 30 of the crowdfunding project 51. Every profit that the crowdfunding project gains will be taxed by the payment unit 23 of the payment center 20 according to the payable tax rate configured in the payment plan 31 of the paperless payment file 30 of the crowdfunding project 51. It is worth mentioning that the crowdfunding project 51 pay taxes directly through the payment center 20 rather than through a third party. The paperless payment system of the present invention further comprises a financial management center 70. The financial management center 70 is respectively communicated and connected with the payment center 20, the tax center 60, and the value constant management center 40. After the payment center 20 has made a payment based on the paperless payment file 30, the payment center 20 will send a payment status receipt 71 to the financial management center 70. The financial management center 70 records the payment statuses on the identifiers 4111 of the payer and the payee respectively according to the payment status receipt, so as for the payer and the payee to understand their expenses and receipts. The financial management center 70 further organizes the expenses and receipts of the user based on the user's request. Preferably, the financial management center 70 manages use's financial position according to the identifier 4111 of the user. Preferably, the accounting management module records the payment statuses on the identifiers of the payer and the payee respectively according to the payment status receipt and inputs them into corresponding accounting items according to accounting provisions, so as to finish the accounting management.

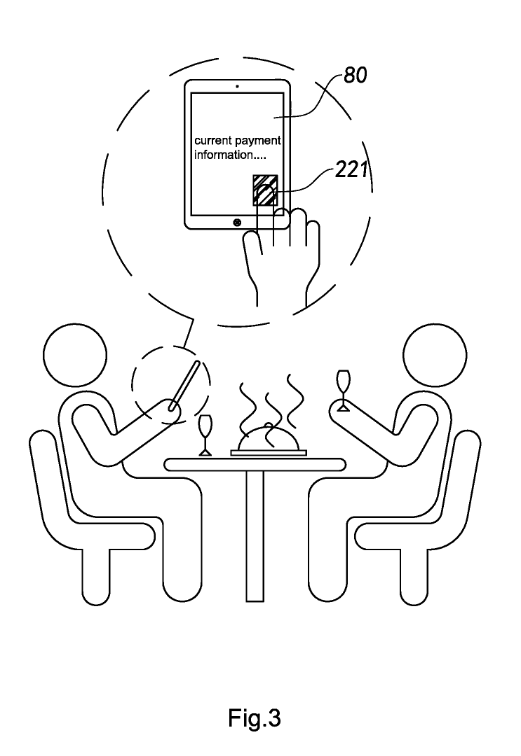

FIG. 3 is a perspective view of a payment scene of the paperless payment system according to the above preferred embodiment of the present invention. The user utilizes the paperless payment file 30 to make a payment in a restaurant. The user utilizes an identity identifying device 221 to identify his/her biological features. The identity identifying device 221 is communicated and connected with the verification unit 22 of the payment center 20. The identity identifying device 221 is utilized for identifying the biological features of the user. According to the present embodiment, it is the user's fingerprint. The restaurant provides a payment terminal 80 communicated and connected with the payment center 20. The payment terminal 80 has a monitor for displaying the consumed items of the user and the required amount of the payment. The monitor is preferably a touch screen. The payment terminal 80 comprises an identity identifying device 221. The user may put his finger on the identity identifying device 221 so as to be identified. The identity identifying device 221 sends the fingerprint information of the user to the verification unit 22. The verification unit 22 searches the identifier 4111 of the user according to the fingerprint information of the user. It can check and search if there is a previously established paperless payment file 30 through the paperless payment file management module 414 according to the fingerprint information of the user in the identifier 4111 of the user. If the user has a previously established paperless payment file 30. Then the verification unit 22 will notice the content acquiring unit 21 to acquire the payment plan 31 of the paperless payment files 30. The content acquiring unit 21 will send the acquired payment plan 31 to the verification unit 22. The verification unit 22 verifies the payment plan 31 and the current payment information. If the current payment information conforms to the payment plan 31, the payment unit 23 will make a payment according to the payment plan 31. If the user does not have a previously established paperless payment file 30, the payment terminal 80 will display the plan providing unit 11 of the generation center 10 for the user to establish a payment plan 31. Then the generating unit 12 will generate the paperless payment file 30 based on the payment plan 31. Then it utilizes the paperless payment file 30 to make the payment. The payment center 23 will respectively transmit the identifier 4111 of the user, the identifier 4111 of the restaurant, and the required payment limit of the user to the value constant management unit 42. The value constant management unit 42 will then transfer the value constant of the amount equal to the payment limit from the identifier 4111 of user to the identifier 4111 of the payee. It is worth mentioning that the tax center 60 can determine if tax is required for the current transaction according to the tax rules. The tax center 60 sends a paperless payment file of tax to the payment center 20, so as to ask the payment center 20 for paying the tax. After the payment center 20 has received the paperless payment file 30 of duty, it will pay the tax according to the paperless payment file 30 of duty. Specifically speaking, the content acquiring unit 21 acquires the content of the payment plan 31 of the paperless payment file 30 of duty. The content acquiring unit 21 acquires that the payer is the restaurant, the taxable identifier 4111, and the taxation amount. The content acquiring unit 21 will send the payment plan 31 of the acquired paperless payment file 30 of duty to the verification unit 22. After the verification unit 22 passes the verification, it will be sent to the payment unit 23. The payment unit 23 will execute the payment according to the content of the payment plan 31 of the paperless payment file 30 after tax.

It is worth mentioning that after the verification unit 22 has obtained the fingerprint and identifier 4111 of the user, the verification unit 22 will acquire the identifier 4111 of the restaurant. Then the verification unit 22 will have access to the paperless payment file management module of the paperless payment file 30 through the content acquiring unit 21, so as to check if the discount paperless payment file 30 provided for the user exists. If there is a discount paperless payment file 30, it will be preferentially processed. The content acquiring unit 11 acquires the content of the payment plans 31 of the discount paperless payment files 30. The payment plan 31 of the discount paperless payment file 30 records the details of the discount. For example, the content of the payment plan 31 of the discount paperless payment file 30 may refer to a 20% discount of the payment of the user. Then the 20% discount of the payment of the user will be transmitted to the verification unit 22. After the verification unit 22 passes the verification, the payment unit 23 will execute the discount paperless payment file 30 to deduct 20% of the payment limit for the user. After the payment unit 23 finishes the execution of the discount paperless payment file 30, the payment terminal 80 will display a discounted payment limit to inform the user the discount result. The user has to operate the identity identifying device 221 again to confirm the payment for the discounted payment limit.

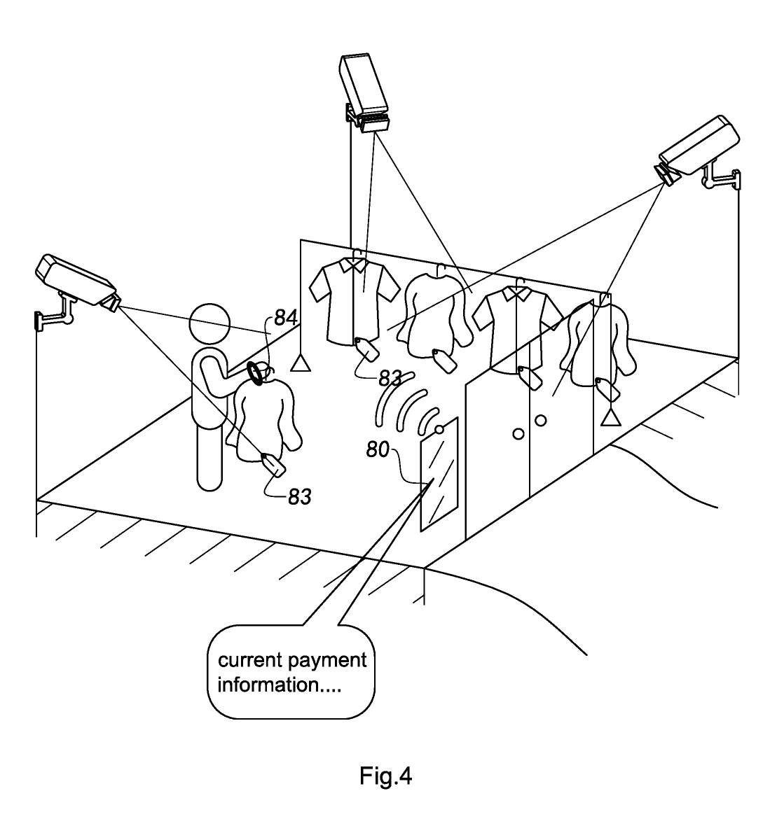

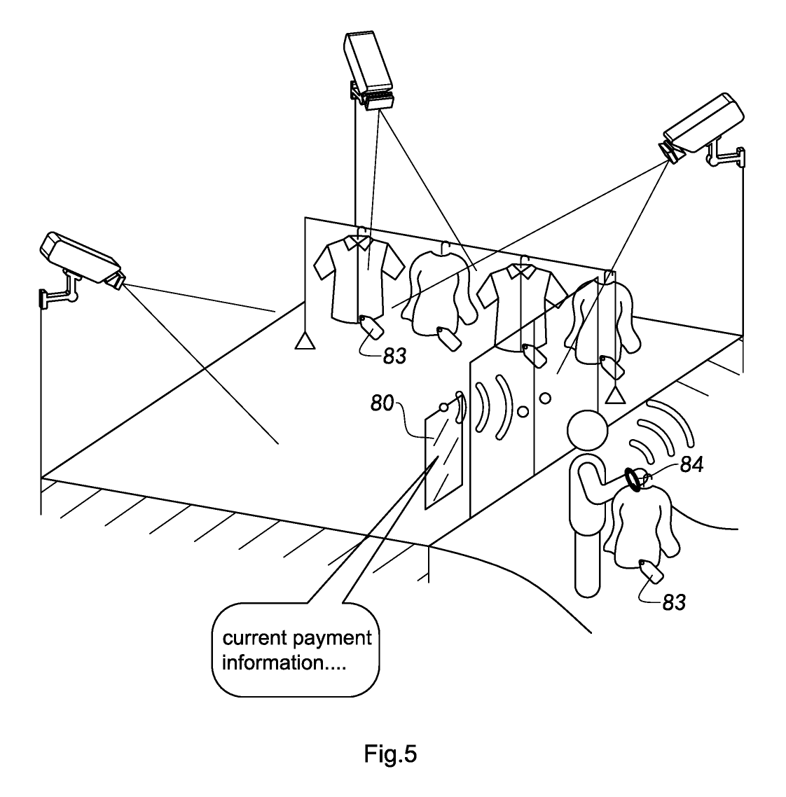

FIGS. 4-5 are payment scenes of the paperless payment system according to another preferred embodiment of the present invention. The user is shopping in a store. At least a payment terminal 80 is provided in the store. The merchandise sold in the store has at least a merchandise information provider 83 provided therewith. The merchandise information provider 83 records information of the merchandise, such as the name, place of origin, producer, required value constant limit, and etc. The merchandise information provider 83 is attached on the merchandise so as to provide corresponding information of the merchandise. Preferably, the merchandise information provider 83 can be embodied as a Radio Frequency Identification (RFID) tag. The user utilizes an identifying medium 84. The identifying medium 84 can store information. The information can be utilized for identity recognition. The identifying medium comprises embedded chips, wearable devices, and smart devices. The embedded chips can be embedded into human bodies. The wearable devices include smartwatches, smart headbands, smart bracelets, smart accessories, smart cloths, smart shoes, and etc. The smart devices include smartphones, tablets, computers, and etc. Preferably, the identifying medium 84 is a wearable device. The identifying medium 45 is communicated and connected with the verification unit 20. The verification unit 22 of the verification unit 20 verifies the identity of the user by acquiring the information on the identifying medium 84. It is worth mentioning that the identifying medium 84 may also identify a person's health facts, such as body temperature, pulse, body odor, blood type, blood pressure, blood sugar, and etc. It also combines these health facts with the stored data for identity identification.

According to the present preferred embodiment, the user utilizes a smart bracelet as the identifying medium 84. The smart bracelet is communicated and connected with the verification unit 20. The smart bracelet provides information to assist the verification unit 20 to identify the identity of the user. When the merchandise is moved from the shelf by the user, the merchandise information provider 83 attached on the merchandise will send a message of leaving the shelf to the payment terminal 80. When the payment terminal 80 receives the message of leaving the shelf of the merchandise, it will acquire the positional information of the merchandise information provider 83 in the store. The payment terminal 80 confirms the positional information of the user through the smart bracelet. If the merchandise and the positional information of the user are at the same position, the payment terminal 80 will confirm that the user has purchased the merchandise. The payment terminal 80 establishes the shopping list based on the information of the merchandise and the information of the user. Before the user left the store, the payment terminal 80 provides the user the value constant limit required for the payment. When left the store, the payment will be made. If the user walks out of the store, the payment terminal 80 will send the shopping list to the payment center 20. The payment terminal also provides the information of the user acquired through the smart bracelet when obtaining the position of the user. The verification unit 22 of the payment center 20 checks if the paperless payment file 30 sent by the user exist from the paperless payment file management module 414 of the merchant according to the information of the user. If there is, it will make a payment according to the paperless payment file 30 of the user and send a notice to the user after the payment has been made.

The paperless payment file may be utilized for online shopping. The user visits an online store for shopping. The user establishes and provides the paperless payment file 30 for online shopping. The user provides the payment plan 31 through the plan providing unit 11. The payer is configured as the identifier 4111 of the user. The payee is configured as the identifier 4111 of the shopkeeper. The user establishes and configures the value constant limit for the payment. The user may further list the quantity and type of the merchandise to buy in the payment plan 31. It is configured in the payment method that the payment will be made after two authorizations and receiving of the merchandise. The two time authorization payment refers to that after the first authorization, the value constant management unit 42 will hold a value constant limit equal to the payment limit in the identifier 4111 of the user, such that the shopkeeper can be informed and certain that the user has the ability to pay and the value constant limit for the payment has been locked. The user authorizes the paperless payment file 30 for online shopping generated according to the corresponded payment plan 31 for online shopping through the authorization unit 13. The generation center 12 will generate the paperless payment file 30 for online shopping according to the corresponded payment plan 31 for online shopping. The paperless payment file 30 for the online shopping will be sent to the identifier 4111 of the shopkeeper. The shopkeeper of the online store may utilize the authorization unit 13 to check the payment plan 31 of the paperless payment file 30 of the online shopping and learn that the value constant of the user for the online shopping has been locked and held for the payment and the condition of payment including pay on delivery. The shopkeeper establishes and provides a paperless payment file 30 for paying the expense of the express delivery service. The shopkeeper establishes the payment plan 31 for express delivery through the plan providing unit 11. The payer is the identifier 4111 of the shopkeeper. The payee is the express delivery service provider. The shopkeeper establishes and configures the value constant limit for paying to the express delivery service. It is configured in the payment method that the payment will be made after two authorizations and the user has received the merchandise. After the shopkeeper has authorized, the generating unit 12 will generate a paperless payment file 30 for the express delivery according to the payment plan 31 for the express delivery. Then the paperless payment file 30 for the express delivery service will be sent to the express delivery service provider. After the express delivery service provider collects the parcel provided by the shopkeeper, she/he will express deliver the parcel to the user based on the address provided by the shopkeeper. The user confirms after receiving the express delivery. The authorization of the payment can be made on the payment terminal 80 provided by the express delivery service provider. It is after the verification unit 22 of the payment center 20 has received the confirmed authorization from the user. The verification unit 22 respectively verifies the paperless payment file 30 for online shopping and the paperless payment file 30 for express delivery. After the paperless payment file 30 for online shopping and the paperless payment file 30 for express delivery has passed the verification, the payment unit 23 will pay according to the payment plan 31 of the paperless payment file 30 for online shopping and the payment plan 31 of the paperless payment file 30 for the express delivery service respectively. The locked value constant limit in the identifier 4111 of the user will be unlocked and paid to the identifier 4111 of the shopkeeper. The locked value constant limit in the identifier 4111 of the shopkeeper will be unlocked and paid to the identifier 4111 of the express delivery service provider.

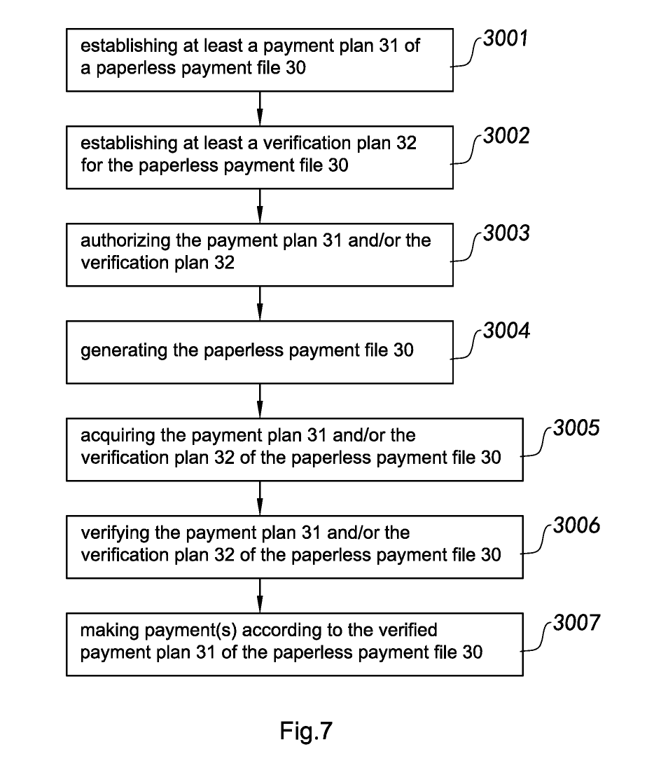

FIG. 7 is a flow diagram of a method of paperless payment of the paperless payment system according to the present invention. The paperless payment system of the present invention comprises the following steps:

Step 3001: establishing at least a payment plan 31 of a paperless payment file 30.

The payment plan 31 allows a payment source to be established. The payment source comprises the value unit and credit limit. If the payment source of the payment plan 31 is configured as the value unit, it will utlize the value unit to make payments. If the payment source of the payment plan 31 is configured as credit limit, the payment unit 23 will utilize the credit limit of the user to make payments. It is worth mentioning that the payment source may be configured as the value unit and the credit limit. When the amount of one of the payment source is insufficient to make the payment, it may utilize another payment source to pay the shortfall. For instance, the payment source of the payment plan 31 is configured as the value unit and the credit limit and the credit limit is configured as the preferential payment source. When the paperless payment file 30 corresponded to the payment plan 31 is utilized to make a payment, the payment unit 23 will preferentially utilize the credit limit of the identifier 4111 of the user to make the payment. If the credit limit of the identifier 4111 of the user is insufficient to cover the payment, the payment unit 23 will utilize the credit limit of the identifier 4111 of the user to make the payment. The payment unit 23 will then utilize the value unit of the user to pay the difference between the payment limit and the credit limit. It is worth mentioning that the payment source of the payment plan 31 may further be configured as an object, or specifically, the right of use and/or ownership of the object, through the plan providing unit 11. When the payment source of the payment plan 31 is configured as the right of use and/or ownership of an object, the payment unit 23 modifies the right of use and/or ownership of the object of the payer and it of the payee respectively through the general information management module 411 of the user management unit 41. If a payment environment is configured in the payment plan 31, the payer also has to provide a proof of the payment environment, such as a photo or video of the payment environment.

Step 3002: establishing at least a verification plan of a paperless payment file 30.

The plan providing unit 11 allows at least a verification plan 32 to be established. Specifically speaking, the verification plan providing module 112 of the plan providing unit 11 provides at least a verification plan 32. The verification unit 22 verifies identities with the verification plan 32. Preferably, the verification unit 22 verifies the identity of the user of the paperless payment file 30 according to the verification plan 32. It is worth mentioning that the verification plan 32 can be designated for corresponding payment plan 31. For example, when there are two payment plans 31 configured in the paperless payment file 30 and when it can configure two verification plans 32 through the verification plan providing module 112, one of the verification plans 32 can be assigned to correspond to one of the payment plans 31 and the other verification plan 32 can be assigned to correspond to the other payment plan 31. When the verification unit 22 verifies one of the verification plans 32 and if one of the verification plans 32 passes the verification, the verification unit 22 will transmit the payment plan 31 corresponded to the verification plan 32 to the payment unit 23. The payment unit 23 executes the payment plan 31 corresponded to one of the verification plan 32.

Step 3003: authorizing the payment plan 31 and/or the verification plan 32.

The authorization unit 13 can authorize the payment plan 31 and/or the verification plan 32. An authorizing person may utilize the authorization unit 13 to review and verify the payment plan 31 and/or the verification plan 32. The authorizing person may utilize the authorization unit 13 to edit the payment plan 31 and/or the verification plan 32. If the payment plan 31 and/or the verification plan 32 is verified, the payment plan 31 and/or the verification plan 32 will be authorized. The payment plan 31 and/or the verification plan 32 will be sent to the generating unit 12.

Step 3004: generating the paperless payment file 30.

The generating unit 12 will generate the paperless payment file 30 according to the payment plan 31 and/or the verification plan 32. The paperless payment file 30 may be stored in the identifying medium 84, such that the content acquiring unit 21 of the payment center 20 may acquire and obtain the paperless payment file 30 from the identifying medium 84. The paperless payment file 30 may also be stored in the user management unit 41, such that the content acquiring unit 21 of the payment center 20 may acquire and obtain the paperless payment file 30 from the paperless payment file management module 414 of the user management unit 41.

Step 3005: acquiring the payment plan 31 and/or the verification plan 32 of the paperless payment file 30.

The content acquiring unit 21 of the payment center 20 will acquire the payment plan 31 of the paperless payment files 30. The acquired payment plan 31 will be sent to the verification unit 22. If the paperless payment file 30 further provides a verification plan 32, the content acquiring unit 21 of the payment center 20 will acquire the verification plan 32 and send the verification plan 32 to the verification unit 22.

Step 3006: verifying the payment plan 31 and/or the verification plan 32 of the paperless payment file 30.

The verification unit 22 analyzes the payment plan 31 of the paperless payment file 30, so as to acquire current payment information through the content acquiring unit 21 according to the payment plan 31 of the paperless payment file 30. For instance, the payment plan 31 of the paperless payment file 30 may require the user to provide information regarding the payment location and payment purpose and the verification unit 22 may acquire the positional information of the payment terminal 80 through the content acquiring unit 21 so as to determine the payment location. The verification unit 22 acquires the content of the payment of the payment terminal through the content acquiring unit 21. The verification unit 22 will compare the payment plan 31 of the paperless payment file 30 to the payment location and payment content in the current payment information. If the payment location and payment content in the current payment information conform to the payment plan of the paperless payment file 30, it will pass the verification.

If the paperless payment file 30 comprises a plurality of the payment plans 31, the verification unit 22 will match the payment plans 31 with the acquiring payment information. If the payment information conforms to one of the payment plans 31, the verification unit 22 will select the payment plan 31. The payment unit 23 will make the payment according to the designated payment plan 31.

The paperless payment file 30 comprises the verification plan 32 and the user may provide the verification information through the payment terminal 80. The verification unit 22 will compare the verification plan 22 of the paperless payment file 30 and the verification information acquired from the payment terminal 80. If the verification information conforms to the verification plan 22 of the paperless payment file 30, then it will pass the verification. Then the verification unit 22 will verify the acquired payment information with the payment plan 31 of the paperless payment files 30. If the acquired payment information matches with the payment plan 31 of the paperless payment file 30, payment unit 23 will make a payment according to the payment plan 31 of the paperless payment file 30.

If the paperless payment file 30 includes a plurality of the payment plans 31 and a plurality of the verification plans 32, and the verification plans 32 and the payment plans 31 correspond to each other in a one-on-one manner. The verification unit 22 respectively matches the verification plans 32 with the verification information. If the verification information matches one of the verification plans 32, the verification unit 22 will select and utilize the payment plan 31 corresponded to the verification plan 32 to verify the payment information. If the payment information conforms to the corresponding payment plan 31, the payment unit 23 will make a payment according to the corresponding payment plan 31.

Step 3007: making the payment according to the verified payment plan 31 of the paperless payment file 30.

The payment unit 23 will make payments from the payment source provided in the payment plan 31 of the paperless payment file 30. If the payment source is configured as the value constant. The value constant management unit 42 will refer to the identifiers 4111 of the payer and the payee and the payment limit acquired from the payment center 23 and then allocate the value constant of the amount equal to the payment limit from the identifier 4111 of the payer to the identifier 4111 of the payee, so as to complete the payment. If the payment source is configured as the credit limit. The payment center 23 will respectively transmit the identifier 4111 of the payer, the identifier 4111 of the payee, and the payment limit to the credit unit 43. The credit unit 43 will deduct the amount of the value constant limit corresponding to the payment limit from the corresponding credit limit of the identifier 4111 of the payer according to the payment limit and the identifier 4111 of the payer. When the payment center 23 detects that the credit unit 43 has finished the deduction from the identifier 4111 of the payer, it will send an identifier 4111 adjustment message to the value constant management unit 42, so as to adjust the value constant limit of the payee. The identifier 4111 adjustment message includes the identifier 4111 of the payee. The value constant management unit 42 adds value constant limit that is equal to the payment limit into the value constant limit of the identifier 4111 of the payee according to the identifier 4111 and the payment limit of the payee.

If the payment source is configured as the credit limit and the value constant, when the credit limit is insufficient, the value constant can be utilized to make payments. Alternatively, if the value constant is insufficient, the credit limit may also be utilized to make a payment. Preferably, the credit limit will be utilized in priority for making payments. For instance, the payment center 23 will transmit the identifier 4111 of the payer, the identifier 4111 of the payee, and the payment limit to the credit unit 43. The credit unit 43 adjusts the credit limit of the identifier 4111 of the payer according to the identifier 4111 of the payer, the payment limit, and the identifier 4111 of the payee. If the credit limit of the identifier 4111 of the payer is insufficient to cover the payment limit, the credit unit 43 will send the difference between the payment limit and the credit limit of the identifier 4111 of the payer to the payment unit 23. The payment unit 23 sensd the identifier 4111 of the payee, the identifier 4111 of the payer, and the difference between the payment limit and the credit limit of the identifier 4111 of the payer to the value constant management unit 42. The value constant management unit 42 will decrease the amount of the difference between the payment limit and the credit limit of the identifier 4111 of the payer from the value constant limit corresponding to the identifier 4111 of the payer. After the amount of the difference between the payment limit and the credit limit of the identifier 4111 of the payer was deducted from the value constant limit of the identifier 4111 of the payer correspondingly, the payment unit 23 will send a identifier 4111 adjustment message to the value constant management unit 42, so as to adjust the value constant limit of the payee correspondingly. The identifier 4111 adjustment message includes the identifier 4111 of the payee. The value constant management unit 42 adds value constant limit that is equal to the payment limit into the value constant limit of the identifier 4111 of the payee according to the identifier 4111 and the payment limit of the payee.

It is worth mentioning that the payment source may be goods configured as the right of use and/or ownership of an object. When the payment source of the payment plan 31 of the paperless payment file 30 is configured as the right of use and/or ownership of an object, the payment unit 23 adjusts the right of use and/or ownership of the object of the payer and it of the payee respectively through the general information management module 411 of the user management unit 41.

It is worth mentioning that, referring to the payment scene illustrated in FIGS. 4-5, the present invention also allows a paperless payment file to be generated in a shopping process.

First, it determines if there is paperless payment file 30 being utilized in the current position of the user.

The current location information and identity of the user can be provided through the identifying medium 84 carried by the user. The identity and current location information of the user will be sent to the verification unit 22 through the content acquiring unit 21. That is to say, the content acquiring unit 21 can acquire the identity and current location information of the user from the identifying medium and send them to the verification unit 22. It is worth mentioning that the current location information of the user will be converted into the address information of the store. The verification unit 22 accesses the paperless payment file management module 414 according to the identity of the user. Further, the identity of the user is the identifier 4111 of the user. Namely, the verification unit 22 searches on the paperless payment file management module 414 with the identifier 4111 of the user and the current location information of the user, so as to verify if there is a paperless payment file 30 utilized by the user at the location. It is worth mentioning that the current location information of the user will be converted into the address information of the store. Namely, the verification unit 22 searches on the paperless payment file management module 414 with the identifier 4111 of the user and the current location information of the user, so as to verify if there is a paperless payment file 30 utilized by the user at the location.

Further, the verification unit 22 searches the identity of the corresponding seller according to the positional information of the user. Further, the identity of the seller is the identifier 4111 thereof. The verification unit 22 searches the paperless payment file 30 with the user identity of the user as the payer and the payment location as the current location information of the user on the paperless payment file management module 414. If the paperless payment file 30 with the identity of the user configured as the payer and the payment location being the same to the current location of the user exists, then the paperless payment file 30 will be utilized. If the paperless payment file 30 with the identity of the user configured as the payer and the payment location being the same to the current location of the user does not exist, the verification unit 22 will search the paperless payment file 30 with the identities of the payer as the user and the payee as the seller. If the paperless payment file management module 414 does have a paperless payment file 30 with the user identity of the seller as the payee and the user identity of the user as the payer, the paperless payment file 30 with the user identity of the seller as the payee and the user identity of the user as the payer will be utilized to make the payment. If the paperless payment file management module 414 does not have a paperless payment file 30 with the user identity of the seller as the payee and the user identity of the user as the payer, then it will execute step 4002.

Then, editing the payment plan 31.

The content acquiring unit 21 acquires the identifiers 4111 of the user and the seller from the verification unit 22 and transmits the identifiers 4111 of the user and the seller to the plan providing unit 11. The plan providing unit 11 edits the payment plan 31 based on the identifier 4111 of the user and the identifier 4111 of the seller. Specifically speaking, the plan providing unit 11 establishes the payment plan 31 based on the identifier 4111 of the user. In the payment plan 31, the payer is configured as the identifier 4111 of the user and the payee is configured as the identifier 4111 of the seller. The identifying medium 84 carried by the user acquires corresponding information of the merchandise through merchandise information provider 83. The merchandise information provider 83 can provide the positional information of the merchandise. Further, the payment terminal 80 may confirm the positional information of the merchandise and the identity and positional information of the user by calling and referring external devices. The external devices may be, for example, a camera. It is worth mentioning that the payment terminal 80 can acquire the identifier of the user and the positional information of the user in the store through the identifying medium 84. The identifying medium 84 acquires corresponding information of the merchandise through merchandise information provider 83. Further, the identifying medium 84 transmits the information of the merchandise, the identity of the user, and the current positional information to the verification unit through the content acquiring unit. After the verification by the verification unit 22, the current positional information will be acquired by the identifier 4111 of the seller and the user's identity will be identified by the identifier 4111 of the user. The information of the merchandise, the identifier 4111 of the user, and the identifier 4111 of the seller will be sent to the plan providing unit 11 through the content acquiring unit 21. The plan providing unit 11 adds the information of the merchandise to the corresponding payment plan 31 based on the information of the merchandise, the identifier 4111 of the user and the identifier 4111 of the seller. The information of the merchandise can be the payment item of the payment plan 31. The identifying terminal 80 detects the relation between the positions of the merchandise and the user. Specifically speaking, the identifying terminal 80 provides a relative position of the merchandise to the merchandise information provider 83 and the positional information of the identifying medium 84 carried by the user. The identifying medium 84 carried by the user can utilize the identifying terminal 80 to acquire a relative position of the merchandise to the merchandise information provider 83 and the positional information of the identifying medium 84 carried by the user. If the distance between the position of corresponded the merchandise information provider 83 of the merchandise and the position of the identifying medium 84 carried by the user is less than or equal to a predetermined value, the payment terminal 80 will regard the position of the merchandise and the position of the user as the same position.

If the user brings the merchandise to the same preset confirmation area, the identifying terminal 80 will further confirm the positional relations between the merchandise and the user. The identifying terminal 80 confirm the merchandise at the same position to the user as the merchandise to buy by the user. The identifying terminal transmits the identifier 4111 of the user, the information of the merchandise, and the identifier 4111 of the seller to the verification unit 22. After the verification of the verification unit 22, the content acquiring unit 21 will send the identifier 4111 of the user, the information of the merchandise, and the identifier 4111 of the seller to the plan providing unit 11. The plan providing unit 11 further checks the identifier 4111 of the user, the information of the merchandise, and the identifier 4111 of the seller. If the information of the merchandise provided by the content acquiring unit 21 does not include the information of the merchandise configured in the payment item, the information of the merchandise configured in the payment item will be deleted. If the information of the merchandise provided by the content acquiring unit 21 includes information of the merchandise that is not in the payment item, then the information of the merchandise will be added into the payment item.

Lastly, the paperless payment file is generated.

The plan providing unit 11 will transmit the payment plan 31 to the generating unit 12 after verification. The generating unit 12 generates the paperless payment file 30 according to the payment plan 31. Then the paperless payment file 30 will be sent to the paperless payment file management module 314. Further, the preset confirmation area is configured at the door of the store.

Further, the payment terminal 80 acquires the position of the merchandise through the merchandise information provider 83 and acquires the position of the user through the identifying medium 84. If the user brings the merchandise for purchase to a preset confirmation area, the payment terminal 80 will confirm that the user has purchased the merchandise he brought. The payment terminal 80 establishes the shopping list based on the information of the merchandise and the information of the user. Before the user left the store, the payment terminal 80 provides the user the value constant limit required for the payment. When left the store, the payment will be made. If the user walks out of the store, the payment terminal 80 will send the shopping list to the payment center 20. The payment terminal also provides the information of the user acquired through the smart bracelet when obtaining the position of the user. The verification unit 22 of the payment center 20 checks if the paperless payment file 30 sent by the user exist from the paperless payment file management module 414 of the merchant according to the information of the user. If there is, it will make a payment according to the paperless payment file 30 of the user and send a notice to the user after the payment has been made.

The terminology “center” and “unit” mentioned and referred in the present specification may comprise software, hardware, or combination of them based on the context provided in the embodiment of the present invention. For instance, the software can be a machine code, firmware, embedded code, application, and etc. In addition, the hardware, for example, can be a circuit, processor, computer, integrated circuit, core of a integrated circuit, micro electro mechanical system (MEMS), passive device, the combination of two or more of the above, and etc.

The above contents are exemplar based on specific embodiments of the present invention. Those devices, structures, and other details that have not been exhaustively described shall be considered adopting and implementing general device(s) and general method(s) in the art.

Besides, the above embodiments of the present invention are only for illustrating and explaining the technology of the present invention, which are examples of the technology of the present invention and shall not limit the technology and claimed scope of the present invention. Those modifications or improvements that apply equivalent technology, equivalent device, and etc. to the technology disclosed in the specification and appended claims of the present invention shall be considered within the disclosed scope of the specification and appended claims of the present invention.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

1-20 (canceled)

21. A paperless payment system, comprising a payment center, which makes a payment according to a preset paperless payment file comprising at least a payment plan, wherein said payment center verifies a current payment information with said payment plan of said paperless payment file, so as to make a payment according to said payment plan of said paperless payment file if the current payment information conforms to said payment plan.

22. The paperless payment system, as recited in claim 21, further comprising a generation center, which generates said paperless payment file, wherein said generation center provides at least one said payment plan that said generation center generates said paperless payment file according to said payment plan provided thereby.

23. The paperless payment system, as recited in claim 22, wherein said paperless payment file comprises at least a verification plan, provided by said generation center, for said payment center to verify identity of the payer according to the verification plan, wherein said payment center makes the payment according to said payment plan of said paperless payment file if the identity of the payer conforms to said verification plan.

24. The paperless payment system, as recited in claim 22, wherein said generation center further comprises a plan providing unit and a generating unit communicated and connected with said plan providing unit, wherein said plan providing unit provides said payment plan, wherein said generating unit generates said paperless payment file according to said payment plan.

25. The paperless payment system, as recited in claim 23, wherein said generation center further comprises a plan providing unit and a generating unit communicated and connected with said plan providing unit, wherein said plan providing unit provides said payment plan and said verification plan, wherein said generating unit generates said paperless payment file according to said payment plan.

26. The paperless payment system, as recited in claim 25, wherein said payment center further comprises a content acquiring unit, a verification unit, and a payment unit interconnected and intercommunicated with one another, wherein said content acquiring unit acquires the current payment information and said payment plan of said paperless payment file and sends the current payment information and said payment plan of said paperless payment file to said verification unit, wherein said verification unit verifies if the current payment information conforms to said payment plan of said paperless payment file, wherein said payment unit makes the payment according to said payment plan of said paperless payment file if the current payment information conforms to said payment plan of said paperless payment file.

27. The paperless payment system, as recited in claim 26, wherein said generation center further comprises an authorization unit communicated and connected with said plan providing unit and said generating unit respectively, wherein said payment plan is examined through said authorization unit, wherein said payment plan will be sent to said generating unit if said payment plan is approved, wherein said generating unit will generate said paperless payment file according to said generating unit.

28. The paperless payment system, as recited in claim 26, wherein said verification unit verifies the identity of the authorized person of said paperless payment file according to said verification plan, wherein said paperless payment file acquires authorization if the verification unit confirms the identity of the authorized person, wherein said payment unit will make the payment according to said payment plan of said paperless payment file.

29. The paperless payment system, as recited in claim 26, further comprising a value constant management center communicated and connected with said generation center and said payment center respectively, wherein said value constant management center manages a value constants of a user account, wherein said paperless payment system makes payments by the value constant.

30. The paperless payment system, as recited in claim 29, wherein said value constant management center further comprises a user management unit and a value constant management unit, wherein said user management unit manages information of the user account, wherein said user management unit arranges corresponding identifier to the user account respectively, wherein said value constant management unit manages the value constant owned by the user account based on the corresponding identifier of the user account.

31. The paperless payment system, as recited in claim 30, wherein said verification unit generates a first verification code according to a biological feature of the user, wherein said user management unit generates a second verification code according to the information of the user account, wherein a user logging on operation is allowed when said first verification code and said second verification code are matched with each other.

32. The paperless payment system, as recited in claim 30, wherein said user management unit further comprises a general information management module, a verification information management module, and a verification information generating module, wherein said general information management module manages general information of the user account, wherein said verification information management module manages verification information of the user account, wherein said verification information generating module acquires said general information and said verification information respectively from said general information management module and said verification information management module, so as to generate the second verification code.

33. The paperless payment system, as recited in claim 32, wherein said plan providing unit further comprises a verification plan providing module, wherein said verification information generating module acquires a part of said general information from said general information management module and a part of said verification information from said verification plan providing module and then edits said part of said general information and said part of said verification information for generating a verification content, wherein said verification plan providing module acquires said verification content from said verification information generating module and provides said verification plan of said paperless payment file accordingly.

34. The paperless payment system, as recited in claim 32, wherein said verification information management module provides at least an emergent verification plan, wherein when said verification unit verifies the identity of the user account, said verification unit calls the police if the identity provided by the user account conforms to said emergent verification plan.

35. The paperless payment system, as recited in claim 32, wherein said user management unit further comprises a paperless payment file management module, for managing said paperless payment file owned by the user account.

36. The paperless payment system, as recited in claim 30, wherein said value constant management center further comprises a credit unit communicated and connected with said user management unit and said value constant management unit respectively, wherein said credit unit provides preset credit limit according to the identifier, wherein said payment plan of said paperless payment file is allowed to be set to make the payment from said credit limit.

37. The paperless payment system, as recited in claim 30, wherein said value constant management center further comprises a value constant appraisal unit, wherein said value constant appraisal unit acquires said general information of the user account through said general information management module for appraising a value constant factor accordingly, wherein said value constant appraisal unit appraises a corresponding value constant according to said value constant factor and a time spending on a program, wherein said value constant equals to product of the value constant factor timing the time spending on the program.

38. The paperless payment system, as recited in claim 30, further comprising a crowdfunding center communicated and connected with said generation center, said payment center, and said value constant management center respectively, wherein said crowdfunding center allows a crowdfunding project to be published, wherein share of each participant of said crowdfunding project is set in said payment plan through said plan providing unit, wherein said generating unit generates said paperless payment file of said crowdfunding project according to said payment plan, wherein after said payment center detects profit acquired by said crowdfunding project, said payment center makes the payment according to said payment plan of said paperless payment file of said crowdfunding project.

39. The paperless payment system, as recited in claim 30, further comprising a tax center, communicating and connecting with said crowdfunding center, said generation center, said payment center, and said value constant management center respectively, wherein said tax center provides at least a tax rule and determines if the payment made by said payment center according to said paperless payment file conforms to said tax rule, wherein if the payment conforms to said tax rule, when making the payment with said paperless payment file based on said tax rule, said tax center makes a corresponding tax payment.

40. The paperless payment system, as recited in claim 39, further comprising an accounting management module, communicated and connected with said payment center, said tax center, and said value constant management center respectively, wherein said payment center sends a payment status receipt to said accounting management module after the payment has been made with said paperless payment file.
